(19) United States
(12) Patent Application Publication
(10) Pub. No.: US 2022/0354070 A1
(43) Pub. Date: Nov. 10, 2022

(54) System and Method for Harvesting and Packing Mushrooms

(71) Applicant: Mycionics Inc., Putnam (CA)

(72) Inventors: Stefan GLIBETIC, Putnam (CA); Anthony Cole MERKEL, Putnam (CA); Caitlin IDZIAK, Putnam (CA); John PHAN, Putnam (CA); Bradley BAS, Putnam (CA); Scott HAYDEN, Putnam (CA); Matthew Arno BERTUZZI, Putnam (CA)

(73) Assignee: Mycionics Inc., Putnam, ON (CA)

(21) Appl. No.: 17/734,715

(22) Filed: May 2, 2022

Related U.S. Application Data
(60) Provisional application No. 63/201,584, filed on May 5, 2021.

(51) Int. Cl. A01G 18/70; A01G 18/62

(52) U.S. Cl. CPC A01G 18/70; A01G 18/62

(57) ABSTRACT

There are provided a system, method(s), and apparatus comprising multiple interacting machines and sub-systems for autonomously/automatically, semi-autonomously/semi-automatically and/or manually harvesting items such as mushrooms from a mushroom bed, wherein the yield and quality of the harvest can be improved over standard methods of harvesting. The system may be referred to as a “harvesting and packing system”, having multiple interacting sub-systems, machines or apparatus to transport and position a harvester at different levels of a multi-layered growing bed, operate the harvester to scan and harvest items from the growing beds, and transfer harvested or “picked” items such as mushrooms to a packer having a stem cutter, discard bin(s) and collection bin(s) to enable fully autonomous harvesting and packing.

### CROSS-REFERENCE TO RELATED APPLICATIONS

This application claims priority to U.S. Provisional Patent Application No. 63/201,584 filed on May 5, 2021, and the entire contents of which is incorporated herein by reference.

### TECHNICAL FIELD

The following relates to systems, methods, and apparatus for harvesting and packing mushrooms, including autonomous, semi-autonomous and manual harvesting using such systems and methods.

### BACKGROUND

The cultivation of Agaricus bisporus (i.e., mushrooms) is an intricate process that requires careful preparation of a substrate in multiple stages and the maintenance of precise environmental conditions during the growth and fruiting. The substrate (i.e., growing medium) used for cultivation is nutritious compost prepared in a special manner with a layer of casing at the top. The casing material should not have any nutrients and should possess good water holding capacity with a texture permitting good aeration and neutral pH level, which causes complex surface and large variation of its height. The casing soil needs to be layered on top of the compost infiltrated with mycelia. Harvesting is to be performed after every flush of growth, approximately every 7 to 10 days. Harvesting is required to be intensive yet accurate, since mushrooms approximately double their size and weight every 24 hours but do not become ripe at the same time. After reaching maturity, the mushroom needs to be quickly picked before the bottom of the mushroom's cap opens. Most of the crop might be harvested within the first two flushes from a single load of bed. One load might give up to four flushes. The growing beds then have to be emptied and sterilized, to kill pests, infections and molds.

Agaricus bisporus is usually grown in multilayer shelving growing bed system for efficient utilization of a farm space and for maximizing yields. This infrastructure allows reaching mushrooms on the whole surface from the sides of the bed by human pickers. The Dutch-type shelving was not designed to accommodate machinery within its boundaries. The beds used for growing mushrooms in the North American region (i.e., in approx. 90% of farms) are more or less standard. Usually, there are only about 16 centimeters of space between mushroom caps and the ceiling of the shelves that can be used for any picking apparatus should one be contemplated.

Currently, mushrooms intended for the fresh market are harvested by hand.

Although the standard grow bed system is suitable for manual harvesting, as previously stated, such systems leave little room for the introduction of automated methods of mushroom harvesting without modifying the infrastructure of the farm or the process of cultivation. For example, the limited vertical space between the stacked grow beds does not allow for the use of standard harvesting systems due to their large size and lack of portability. Additionally, the limited space creates difficulty for standard camera imaging systems as they can only see small portions of the growing bed or suffer from distortions and mushroom occlusions if oriented towards the bed at an angle. Furthermore, mushrooms and their growing environments experience highly dynamic properties while growing (e.g., varying ambient light sources, mushroom color, shape, size, orientation, texture, neighborhood density, and rapid growth rate). The variation of these properties creates difficulties for consistent and precise detection of mushroom properties via optical image processing algorithms.

A mushroom grows at an accelerated rate in a controlled growing room environment. In order to increase the yield a grower will introduce a growth stagger which achieves multiple waves of mushroom growth within the same square meter of growing space. Selective harvesting is the process of harvesting a specific mushroom at the optimal size to maximize crop yield. Neighboring mushrooms also have an effect on the mushrooms around them so the selective harvesting process can be complex. Selective harvesting also includes the identification and harvesting of a smaller sized mushroom in order to provide room for adjacent, larger mushroom to grow to maximize size.

Depending on the commercial mushroom farm operation manual (human) harvesters are instructed to pass over the mushroom beds multiple times throughout the day to try and achieve the theory of selective harvesting. Manual harvesting is unable to achieve true selective harvesting because of difficulties in accurately measuring the diameter of a mushroom with your eyes, differences in a harvester training retention and a harvester's experience all which results in variation in the harvest results and reduction to crop yield. Further, manual harvesting is typically conducted during a single 8-10 hour shift which can result in mushroom harvested at the end of the shift being picked before they are at an optimal size. If a mushroom is not picked at the end of the shift the growth overnight could cause the mushrooms to exceed the target size and the resulting product becomes waste (e.g., an open mushroom that is too small).

FIG. 1 is a photograph of the front view of a single level or shelf of a typical Dutch-style multilayered grow bed. The photograph clearly shows mushrooms at different stages of development, mushrooms growing in groups (often referred to a “clusters”), mushrooms growing upright, mushrooms grown sideways, and so forth.

Attempts have been made to automate the harvesting (picking) of a mushroom, but so far these have been met with limited to no success. Two major flaws in previous attempts to automate mushroom harvesting are: 1) damage (bruising) to the mushroom by the picking devices, and 2) the requirement to transport the growing medium including mushroom(s) to the picking device.

Mushrooms are a very delicate produce and using vacuums and/or suction cups to detach a mushroom from the substrate will most likely cause damage to that mushroom making it non-saleable. Sometimes the damage on the mushroom is not noticeable initially but while sitting in the cooler (e.g., within 24 hours) bruising will become more evident. The issue with transporting the growing medium to the harvester is that it requires a lot of energy and it disturbs the growing environment of the mushrooms. A mushroom growing room has been specifically designed to create an evaporative environment for the ideal mushroom growing environment through the controlling of air flow, humidity, and temperature. That is, by removing the mushrooms and growing medium from this environment you are adversely affecting the growing of mushrooms.

The use of 2D cameras to capture images of the mushrooms has been previously considered and the difficulty of extracting precise mushroom information is demonstrated by the need of using additional methods of measurements and complex processing algorithms that are sensitive to the dynamic properties of mushrooms and their growing environment. Furthermore, the rapid growth rate of mushrooms generates a small window that is ideal for picking mushrooms at the appropriate size and creates the need for high speed mushroom detection and harvesting that satisfy industrial demands. The quality of the mushroom upon picking depends on the method of grasping and the accuracy of the detected mushroom parameters, where slight inconsistencies in the detection stage may result in mushroom bruising or cutting of the mushroom.

There remains a need for fully automated methods and systems for harvesting a single mushroom and multiple mushrooms from a mushroom bed or stacked mushroom beds, which reduces damage to mushroom caps, maximizes yield through selective harvesting, and are able to support pre-existing growing room infrastructure and conditions.

It is an object of the following to address at least one of the above-noted disadvantages.

### SUMMARY

The following provides a system, method, and apparatus for autonomous, semi-autonomous and manual harvesting and packing of mushrooms that addresses the above challenges and can enable an industrial standard of mushroom harvesting while adapting to and leveraging the existing infrastructure to avoid large modification costs.

In one aspect, there is provided a method of harvesting items grown in growing beds, the method comprising: i) loading a harvester onto a lift, the harvester comprising a vision system to scan and detect items in growing beds and a picker for picking items growing in the growing bed; ii) operating the lift to attach to and climb the growing bed to a specific one of a plurality of levels of the growing bed; iii) enabling the harvester to be deployed onto the specific level of the growing bed; iv) moving a packer to be aligned with the specific level and an area of the specific level and be configured to receive items picked by the picker; and v) repeating steps i), ii), iii), and iv) for a next area to be picked, wherein the next area is part of the same specific level of the growing bed, a next specific level of the growing bed, or a next growing bed.

In another aspect, there is provided a harvesting system, comprising: a lift attachable to a growing bed and configured to climb between a plurality of levels of the growing bed; a harvester comprising a vision system to scan growing beds and a picker for picking items growing in the growing bed; a packer attachable to the growing bed and moveable along the length of the bed and between a plurality of levels of the growing bed to align with the harvester to transfer picked items from the harvester to the packer; and a control system to automate at least one of the harvester, lift and packer.

In another aspect, there is provided a lift for a mushroom harvesting system, the lift being attachable to a growing bed and configured to climb between a plurality of levels of the growing bed.

In yet another aspect, there is provided a packer for a mushroom harvesting system, the packer attachable to the growing bed and moveable along the length of the bed and between a plurality of levels of the growing bed to align with the harvester to transfer picked mushrooms from the harvester to the packer.

In yet another aspect, there are provided methods for manual, semi-autonomous, or autonomous mushroom scanning, harvesting and packing as described herein

In yet another aspect, there is provided a computer readable medium comprising computer executable instructions for performing the above method(s).

### BRIEF DESCRIPTION OF THE DRAWINGS

Embodiments will now be described with reference to the appended drawings wherein:

FIG. 1 is a photograph of an end view of a single level of a multilayered growing bed.

FIG. 2 is a perspective view of a multilayered growing bed with an automated harvesting and packing system deployed thereon.

FIG. 3 is a perspective view of a multilayered growing bed in isolation with interface elements attached to deploy the automated harvesting and packing system.

FIG. 4a is an enlarged perspective view of a rack coupled to vertical rails of a multilayered growing bed for lifting an automated harvester between levels.

FIG. 4b is an enlarged perspective view of an alignment plate for aligning adjacent rails to form a continuous rail surface between growing bed sections.

FIG. 5 is a perspective view of a lifter supported by a transport dolly, the lifter for lifting an automated harvester between levels of a multilayered growing bed.

FIG. 6 is a side view of the lifter positioned on the dolly in an upright orientation.

FIG. 7 is a side view of the lifter positioned on the dolly in a level orientation.

FIG. 8 is a perspective view of an automated harvester.

FIG. 9 is a side view of the automated harvester positioned atop the lifter and dolly.

FIG. 10 is a perspective view of the automated harvester positioned atop the lifter and dolly.

FIG. 11 is a perspective view of the dolly in isolation.

FIG. 12 is a perspective view of the lifter and automated harvester positioned in alignment with a level of a multilayered growing bed to permit the automated harvester to access that level.

FIG. 13 is a perspective view of the automated harvester while moving from the lifter onto the level of the multilayered growing bed.

FIG. 14 is a perspective view of automated harvester after being deployed onto the level of the multilayered growing bed from the lifter.

FIG. 15a is a perspective view of an extender projectable from the lifter to align with a rail of a multilayered growing bed, in a retracted position.

FIG. 15b is a perspective view of the extender of FIG. 15b in an extended position.

FIG. 16 is a perspective view of the automated harvester moving along the bed rails during a scanning operation.

FIG. 17 is a perspective view of an automated packer to be used with the automated harvester on a multilayered growing bed.

FIG. 18 is a perspective view of the automated packer coupled to a packer rail installed alongside a rail of a multilayered growing bed.

FIG. 19 is an enlarged perspective view of a gripper of the automated harvester, in isolation.

FIG. 20a is an enlarged perspective view of a stem cutter of the automated packer.

FIGS. 20b-20e illustrate operation of a cam mechanism of the stem cutter.

FIGS. 21 to 23 are perspective views illustrating picking and transfer operations between the gripper and stem cutter.

FIG. 24 is a perspective view illustrating the stem cutter holding a transferred mushroom.

FIGS. 25a to 25d are perspective views of the stem cutter in isolation during a cutting operation.

FIGS. 26 to 28 are perspective views of the stem cutter discarding of a stem and placing a mushroom in a packer bin.

FIG. 29a is a perspective view of a portion of the packer illustrating a box management system.

FIGS. 29b-29x are a sequence of diagrams to illustrate operation of the box management system.

FIG. 30 is a perspective view of the box management system in isolation.

FIG. 31 is a perspective view of a box transfer mechanism in isolation.

FIG. 32 is a side view of the packer with a box transferred from the box management system.

FIG. 33 is a perspective view of the packer with a large discard bin.

FIG. 34 is a perspective view of the large discard bin in isolation.

FIG. 35 is a perspective view of a portion of the packer aligned with a sticker plate for detecting a position of the packer relative to the multilayered growing bed.

FIG. 36 is a flow chart illustrating a set of computer executable operations performed in an example of a data collection mode.

FIG. 37 is a flow chart illustrating a set of computer executable operations performed in an example of an operator controlled harvesting mode.

FIG. 38 is a flow chart illustrating a set of computer executable operations performed in an example of an autonomous harvesting mode.

### DETAILED DESCRIPTION

The following provides a system, method(s), and apparatus comprising multiple interacting machines and sub-systems for autonomously/automatically, semi-autonomously/semi-automatically and/or manually harvesting items or other growing material such as mushrooms from a mushroom bed, wherein the yield and quality of the harvest can be improved over standard methods of harvesting. While the examples given below are in the context of mushrooms and mushroom farming, the principles equally apply to any item or growing material in a growing bed, including various materials grown in vertical farming applications.

The system, in one implementation, may be referred to herein as a “harvesting and packing system”, having multiple interacting sub-systems, machines or apparatus to transport and position a harvester at different levels of a multi-layered growing bed, operate the harvester to scan and harvest mushrooms from the mushroom beds, and transfer harvested or “picked” mushrooms to a packer having a stem cutter, discard bin(s) and collection bin(s) to enable fully autonomous harvesting and packing.

The harvester sub-system (also referred to as the “harvester” for brevity) can include at least an apparatus/frame/body/structure for supporting and positioning the harvester on a mushroom bed, a vision system for scanning and identifying mushrooms in the mushroom bed, a picking system for harvesting the mushrooms from the bed, and a control system for directing the picking system according to data acquired by the vision system. Various other components, sub-systems, and connected systems may also be integrated into or coupled to the harvester sub-system as discussed in greater detail below.

The vision system as described herein can be implemented in a “rail” or other module integrated into the apparatus of the harvester sub-system to position vision components for scanning and acquiring data of the underlying mushroom bed. The mushroom bed is meant to support a substrate in which mushrooms grow and are to be harvested. The harvester sub-system described herein is configured to move along existing rails of the growing bed, e.g., in a Dutch-style multilayered growing bed to scan and pick periodically and preferably continuously without the need for manual harvesting. The vision system can detect mushrooms, their properties (e.g., position, size, shapes, orientations, growth rates, volumes, mass, stem size, pivot point, maturity, and surrounding space), statistics, and the strategies required for instructing the picking system for autonomous mushroom harvesting.

The rail or module of the vision system can include a precisely machined structure designed to hold one or multiple 3D data acquisition devices or scanners, data routing devices, communication modules, and one or more processing units. Power can be provided by a separate rail or module, herein referred to as a “battery rail”.

The harvester may traverse mushroom growing beds in an automated fashion and may contain mushroom grasping and manipulating technologies (embodied by the picking system), therefore increasing the ability of the overall system to harvest mushrooms of the highest quality and yield within the requirements of industrial production.

The lift sub-system is designed to position and interface the harvester with the growing bed and lift the harvester between all levels of the growing bed with minimal added functionality and infrastructure required. The lift sub-system (also referred to herein as the “lift” or “lift system”) can include a dolly or cart to transport the lift as well as a harvester supported on the lift. The lift attaches to posts of the growing bed and traverses these rails using a combination of swing-arms, rollers, and rack and pinion mechanisms. The lift also used optical sensors to automatically detect each level in the growing bed and can employ a bridging mechanism to permit seamless transfer of a harvester onto a desired level in the growing bed.

The packer sub-system (also referred to herein as the “packer” or “packer system”) is designed to receive mushrooms from the harvester in a transfer operation, cut the stems of the transferred mushrooms, and pack the mushroom caps (with stems/stem portions removed) into boxes. The packer can also incorporate functionality to weigh the boxes as mushrooms are packed and to transfer full boxes away from a transfer zone in place of fresh (empty) boxes.

These various sub-systems or machines interact with each other to provide an end-to-end harvesting system that collects data, semi-autonomously, autonomously, or operator controlled, harvests and packs mushrooms using one or more sets of harvesters, packers and lifts per growing bed, as well as employing a central management server. Using the collected data and the interoperable machines, an optimized harvesting methodology can be employed when compared to traditional manual harvesting techniques.

That is, the sub-systems and machines described herein have the ability to attach to common mushroom growing infrastructure, harvest mushrooms up to 24 h/day, target any desirable mushrooms, and cover the area of the bed sufficiently enough to allow for any target sized mushroom to be harvested (picked, cut, packed and weighed) at any time throughout the harvesting cycle. In addition to harvesting capabilities, the machines have the ability to collect and process compost, mushroom, and growing room condition data. Using the machines' harvesting capabilities, paired with the data collection methodology, the overall harvesting system can thus optimize the desired harvesting parameters and schedules so that mushrooms are always picked at the target size and target time. This data-driven method of harvesting mushroom minimizes common issues which lead to yield reduction, such as harvesting undersized/oversized/low quality mushrooms, and the poor management of harvesting schedules, leading to overharvesting mushrooms, undesirable mushroom stagger, mushroom clustering and premature reproduction cycles.

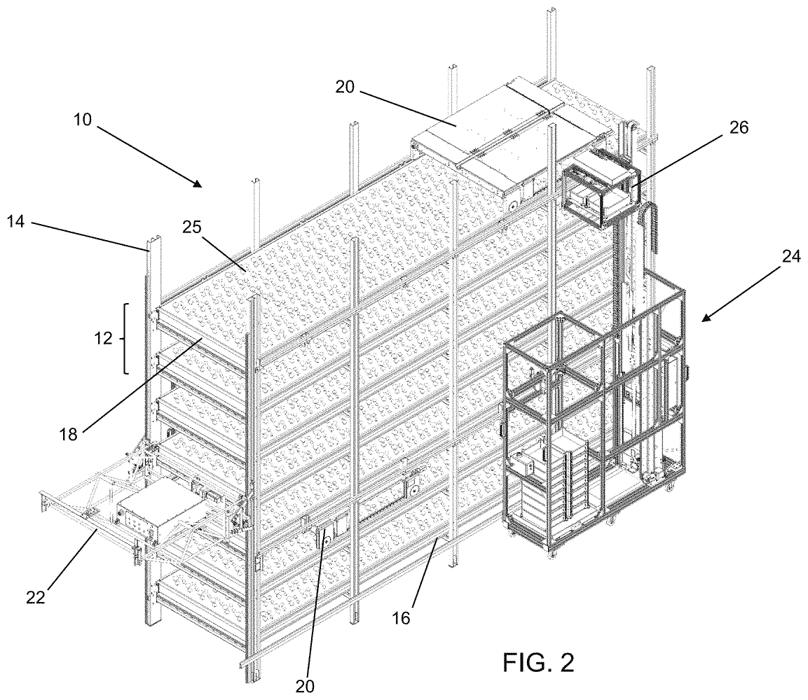

Turning now to the figures, FIG. 2 illustrates an example of a standard (e.g., Dutch-style) multilayered growing bed assembly 10 for indoor mushroom growing. It can be appreciated that some components of the growing bed assembly 10 are omitted from FIG. 2 for ease of illustration. The growing bed assembly 10 is constructed to create a plurality of layers or levels 12 (one of which is numbered in FIG. 2). The growing bed assembly 10 includes a number of vertical posts 14 and a pair of side rails 16 at each level 12. The vertical posts 14 and side rails 16 are positioned at a standard distance from each other by a number of cross beams 18. The cross beams 18 tie the vertical posts 14 together to form each level 12 and support the substrate, i.e., growing medium such as compost. Each cross beam 18 includes a number of square-shaped apertures in this example through which square beams (not shown) can be inserted to support the substrate.

Also shown in FIG. 2 are a pair of automated harvesters 20 that are each positioned at a different level 12 to illustrate both their mobility and adaptability within the constraints of the standard growing bed assembly 10. A lifter 22 is also shown, coupled to one end of the bed 10 and is currently positioned at one of the levels but can traverse the vertical rails 14 to be positioned at any of the levels 12, e.g., to move one of the harvesters 20 from one level 12 to another. A packer 24 is also shown, which is coupled to the bed 10 along one of the side rails 16 such that the packer 24 can position itself in aligned with the harvesters 20 as they move along the bed 20. The packer 24 is also telescopic to permit a transfer frame 26 thereof to be positioned in alignment with a desired level 12 of the growing bed 10.

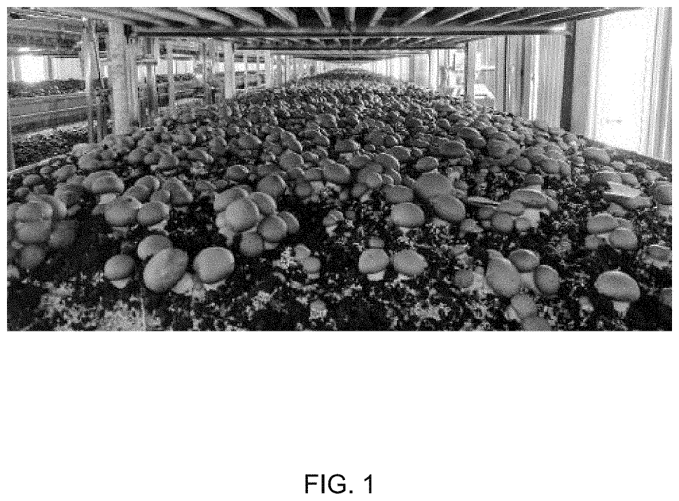

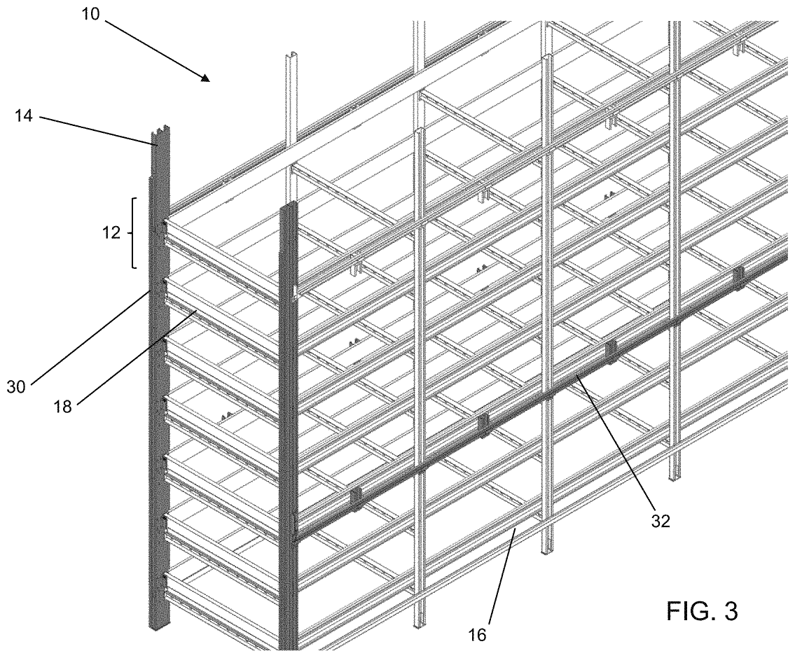

FIG. 3 illustrates the growing bed 10 in isolation to highlight modifications to the growing bed 10 made to couple the lift 22 and packer 24 to the bed 10 (highlighted with darkened shading). Along each of the vertical rails 14 at one end of the bed 10 (although could also be at both ends), a rack 30 is attached, which is used in a rack and pinion mechanism employed by the lift 22 to traverse the growing bed 10 between levels 12. Along one of the side rails 16 a packer rail 32 is attached to facilitate movement of the packer 24 along the length of the growing bed 10 as illustrated in FIG. 1. It can be appreciated that if more than one packer 24 is used, they can all share the same common packer rail 32 per side of the growing bed 10. Similarly, if packers 24 are positioned on both sides of the growing bed 10, a packer rail 32 can be attached to both sides of the growing bed 10.

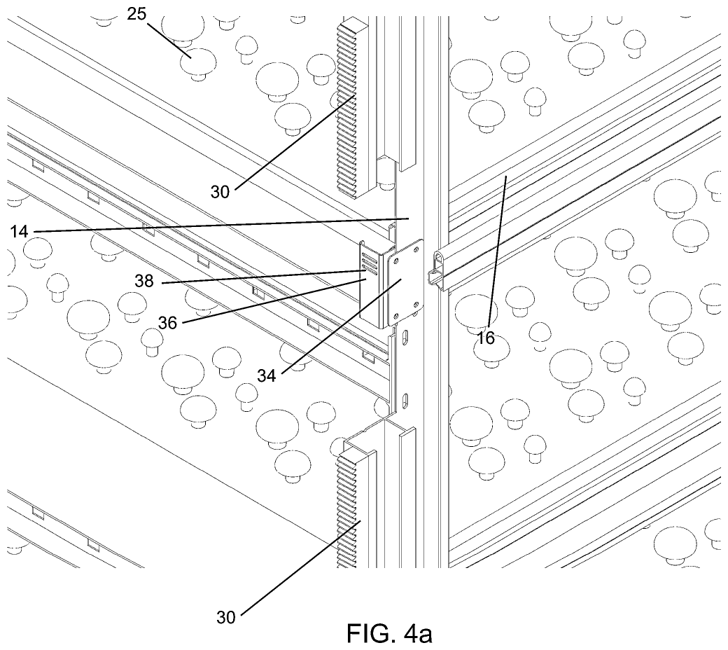

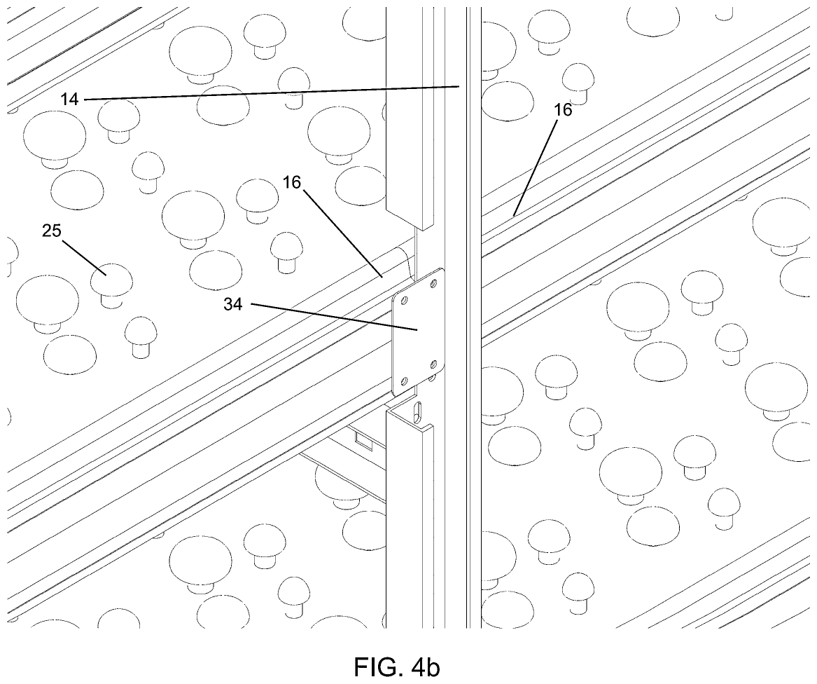

Referring now to FIG. 4a, portions of the rack 30 are shown in greater detail with a central portion removed in this view to provide a closer view of an alignment plate 34. The alignment plate 34 is multipurpose and, as shown in FIG. 4a, this can include aligning the bed rail 16 with a level detection plate 36 that includes a set of markings 38 to uniquely identify the particular level 12. The alignment plate 34 can also be used, as shown in FIG. 4b, to align the rails 16 to each other to form a long, continuous and smooth rail surface for the entire length of the growing bed 10. The alignment plate 34 when used for rail-to-rail alignment is advantageous as it ensures that the rails 16 are aligned with each other, without gaps/steps between them, thus allowing the harvester 20 (or any other machine adapted to move along the rails 16) to smoothly roll down the full length of the bed 10 without difficulty. This addresses a common rail misalignment issue see with standard mushroom growing beds 10. The rail misalignment occurs because of the slotted holes that are normally used to fasten the rails 16 to the posts 14 and, over time, the rails 16 begin to misalign due to regular use. Another benefit of the alignment plate 34 is that it reduces the need for continuous maintenance. That is, once installed, the rails 16 are more likely to stay aligned unless physical damage occurs to the plate 34 and/or rail 16.

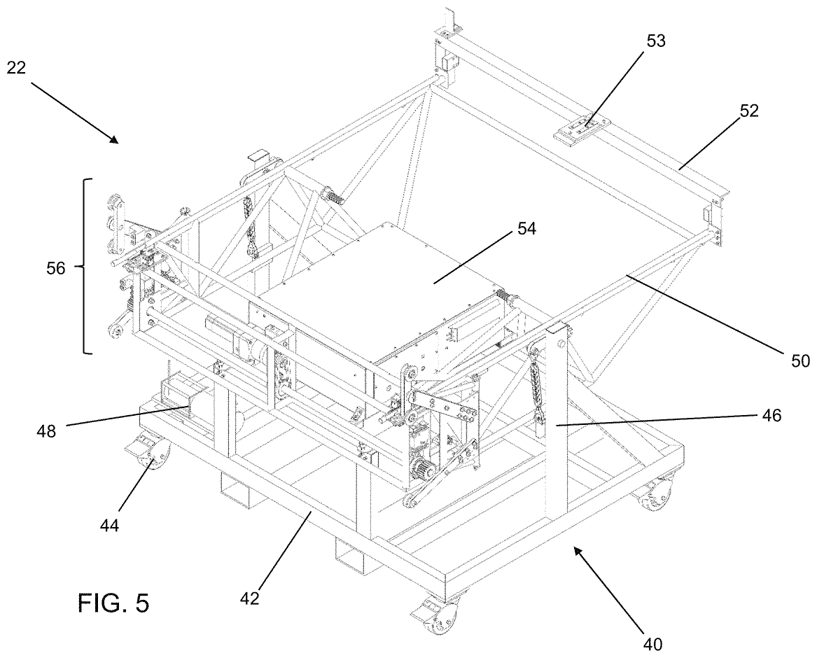

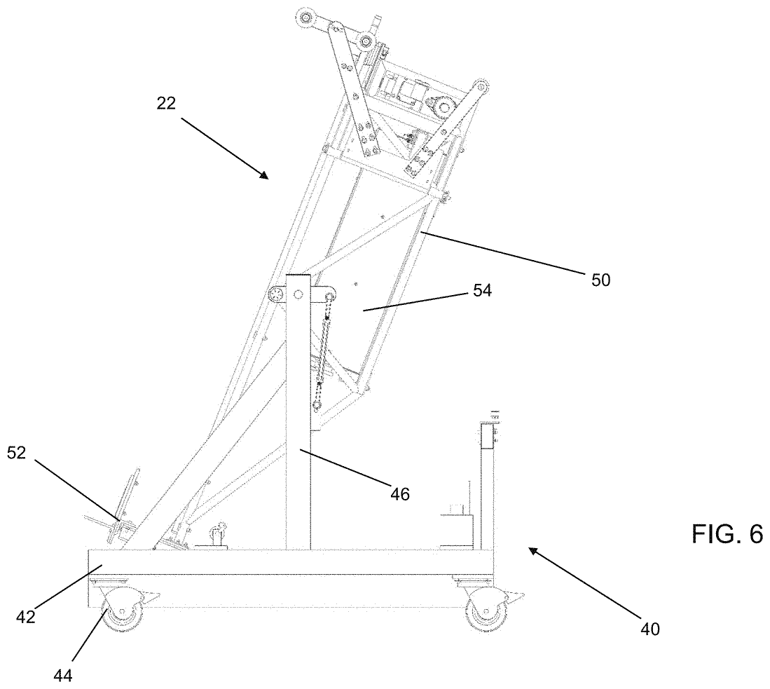

FIG. 5 illustrates the lift 22 supported by a carrier cart 40 to enable the lift 22 to be transported to and from growing beds 10 and/or between different ends of the same growing bed 10. The cart 40 includes a base frame 42 that is supported and given mobility using a set of casters 44. A pair of upstanding supports 46 extend from the base frame 42 on opposite sides to rotatably support the lift 22. The rotation of the lift 22 on the cart 40 is illustrated in FIG. 6. This ability to tilt the lift 22 during transport allows for a more stable and compact form factor during transport. The cart 40 can also include a winch 48 to assist the operator with tilting the harvester/lift 20, 22 while on the carrier cart 40.

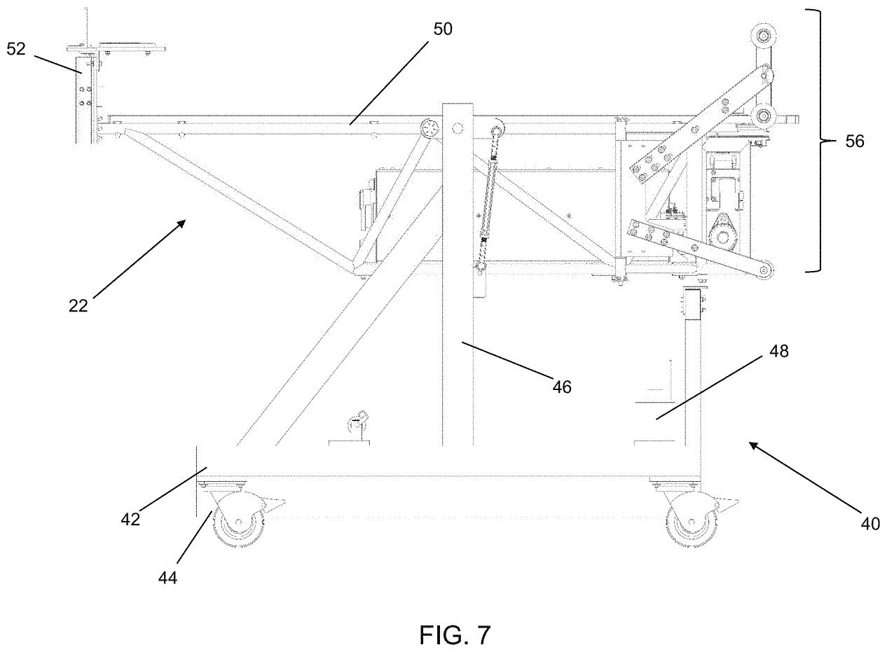

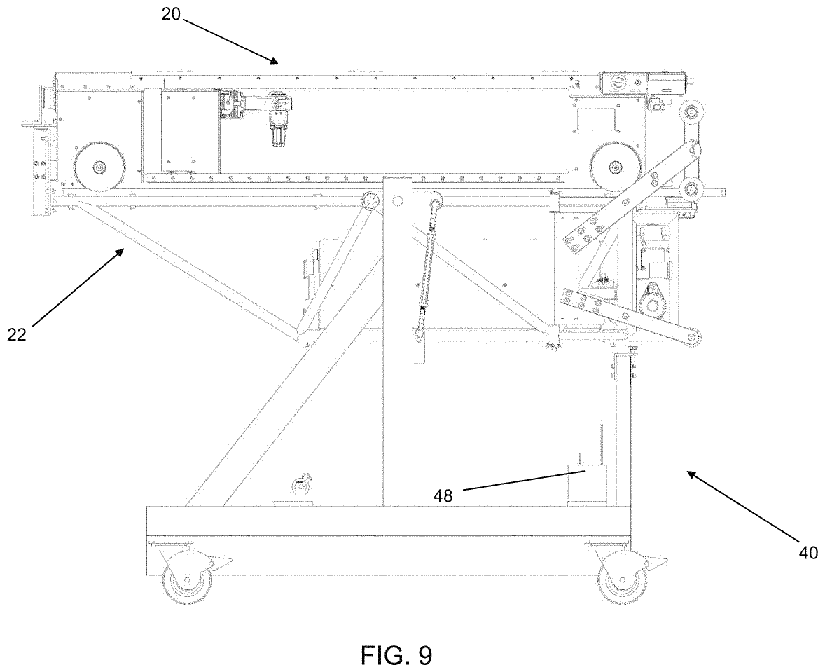

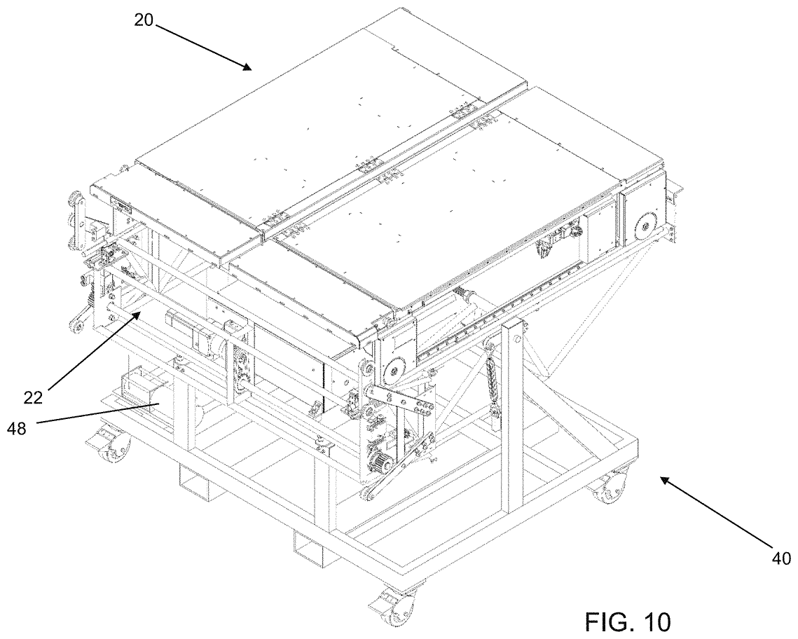

The lift 22 includes a frame 50 that acts as a rack or platform on which the harvester 20 can be supported to transport same to/from the growing bed 10 or between ends of the same growing bed 10, for example. The frame 50 includes a backstop 52 to inhibit movement of the harvester 20 off the back of the lift 22 when supporting the harvester 20 for transport and/or lifting operations, as seen in FIGS. 9 and 10. The lift 22 also includes a control module 54 that contains the control electronics, communication and power distribution systems, and operates a pair of roller assemblies 56, which engage the vertical posts 14 and racks 30 attached thereto. The roller assemblies 56 can be operated to ascend or climb the growing bed 10 to align with different levels 12 to permit the harvester 20 to drive off the lift 22 and onto that level 12. The lift 22 has the ability to charge the batteries of the harvester 20 using a dock charger 53 located along the backstop 52. The dock charger 53 is magnetically activated when the harvester's charging pads are in close proximity of the dock charger 53. In this way, the harvester 20 can automatically charge while resting on the lift 22, without assistance from human operators. This is also advantageous when the harvester 20 is resting at a high level 12 of the growing bed 10 which would be difficult to access without returning the lift 22 to the ground level. As seen in FIG. 7, the roller assemblies 56 project beyond the front of the carrier cart 40 to permit the carrier cart 40 to position the lift 22 up to and against the growing bed 10 and attach to the growing bed 10 as described in greater detail later. The lift 22 is not permanently attached to a single growing bed 10 or to one or the other end of the growing bed 10 but can be attached and detached to any vertical posts 14 that are adapted to interface with the roller assemblies 56. That is, the lift 22 has the mobility to be transported between beds 10 using the carrier cart 40 with minimal physical effort by a human operator.

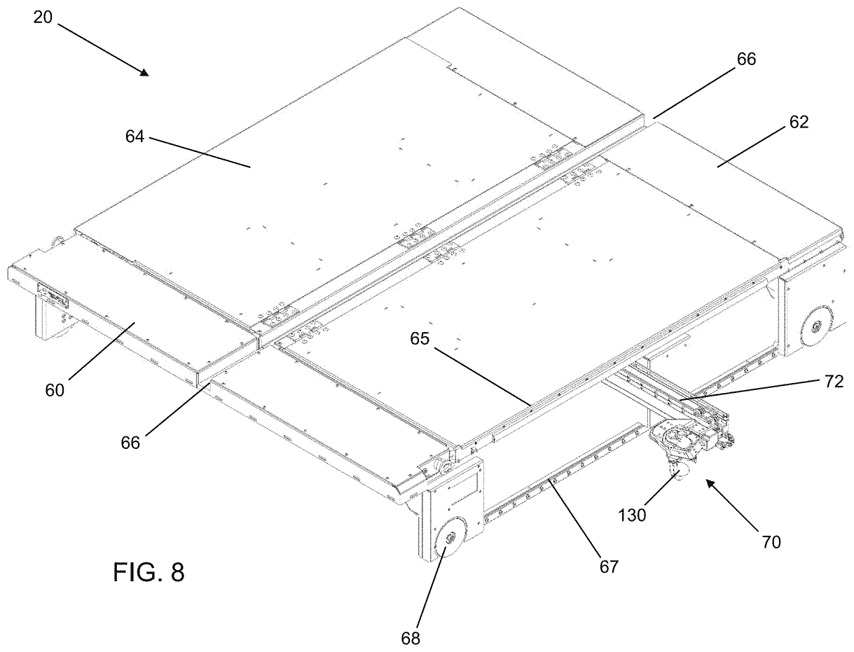

FIG. 8 illustrates a perspective view of the harvester 20 in isolation to provide additional detail. In a standard growing bed 10, a series of irrigation sprinklers typically extend downwardly from the level 12 above. The harvester 20 is configured to include a longitudinal slot or channel 66 through the components of the harvester 20 that would otherwise interfere with the sprinklers, providing yet another example of adaptability of the harvester 20 with the standard equipment. The channel 66 extends between a vision system rail 60 and a battery rail 62 and through a cover portion 64 which can be used to shield the harvester 20 from dripping water and to provide a safety shield.

Also shown in FIG. 8 is a gantry 72, which corresponds to the components of the picking system that couple a gripper 70 to the frame of the harvester 20 and which enable movement or translation of the picking system in the X (longitudinal), Y (lateral), and Z (vertical) axes. Below the axes of the gantry 72 may be referred to as the gantry's X axis, the gantry's Y axis and the gantry's Z axis to denote the components of the gantry 72 that permit movement or translation along the corresponding axis or direction. The gantry 72 can include a motor for moving the gripper 70 in the X direction, a motor for moving the gripper 70 in the Z direction, and a motor for moving the gripper 70 in the Y directions. Movement in the X direction is aided by the liner guides provided by the cover portion 64 as can be appreciated from the view in FIG. 8.

The cover 64 provides an indication of the picking workspace afforded to the harvester 20. With the open areas created between upper and lower rails 65, 67, there can be provided both an internal picking workspace in the lateral or “Y” dimension (width) and an additional telescoping drop off workspace in the lateral or “Y” dimension wherein the gripper 70 can telescope beyond the side rails 16 of the bed 10. For example, the harvester 20 can be configured to provide approximately 1250 mm internally and 2000 mm telescoping, providing 375 mm of reach beyond the rails 16.

The gantry's X axis is connected to the frame via the linear guides discussed above that are precisely positioned and aligned on the top of the frame. The gantry 72 is driven along its X axis via a rack and pinion mechanism to allow for multiple independent X axes i.e. independent picking gantries within the same frame. The gantry 72 slides along its X axis over the linear guide using pillow blocks with internal rollers. The left and right side follow the same indexed for left and floating for right side mechanism as described previously to prevent binding/dynamic friction when bed intolerances that skew the frame are encountered. The gantry's rack and pinion for its X axis can have a spring-loaded mechanism (located on the subassembly for permitting movement in the Z axis—described below) that keep the correct meshing between gears even when the harvester's frame encounters skewing from the rails 16.

The component(s) of the gantry 72 that permit movement along its Z axis (height) is/are coupled relative to the component(s) of the gantry 72 that permit movement along its X axis and is/are custom designed for compactness while providing very high stroke length (e.g., 130 mm) relative to the overall height of the gantry's Z axis. The gantry 72 can be driven in the Z direction via high pitch lead-screw (for speed) with a self-lubricating anti-backlash nut, supported by the linear guide rail that is self-cleaned using a pad. The gantry 72 can be driven in the Z direction by a pulley mechanism with a specifically chosen ratio to prevent the gantry 72 from dropping in case of power loss of the motors. If the gantry 72 drops vertically while on the growing beds, it can damage itself, the gripper 70, and the mushrooms 25 below, or can get stuck in the bed. The pulley mechanism can also have a spring-loaded belt tensioning mechanism to help with dynamic tension adjustments. The left and right side of the gantry's Z axis components can be independently driven for performance and are consistent with the indexed vs floating approach described herein. The bottom of the gantry's Z axis subassembly can have spring-loaded wheels which travel along v-groove lower rails 67 mounted on the bottom of the harvester frame to help align the gantry 72 in the Z axis during motion as well as providing a dynamic meshing mechanism for the rack and pinion used to permit movement of the gantry 72 along the X axis. The gantry's Z axis sub-assembly can be enclosed within covers to reduce water/humidity damage and have an active cooling mechanism for the motors.

The component(s) of the gantry 72 that permit movement along its Y axis (width) is/are coupled relative to the component(s) of the gantry 72 that permit movement along its Z axis and serve(s) the purpose of manipulating the position of the gripper 70 in the Y direction along the width of the mushroom bed 10 as well as to telescope outside of the bed, e.g., up to 375 mm to either side of the rails 16. The total stroke of the gantry 70 along its Y axis can therefore be up to two meters. To achieve the telescoping mechanism, the gantry's Y axis can be split into two parallel axes, i.e., Y1 and Y2. The telescoping mechanism allows the harvester 20 to deliver mushrooms 25 (i.e. position the gripper 70) outside of the bed while also being able to avoid bed posts when the harvester 20 is moving forward. The gantry's Y axis is configured to have a very narrow vertical profile to be able to traverse the bed above the mushrooms 25 and below the sprinklers. The gantry's Y axis can be both belt and leadscrew-driven in order to achieve high precision, yet also very high speed, in order to pick and deliver mushrooms 25 quickly without damaging them.

It can be appreciated that the gantry's Z axis includes a drive mechanism, including a belt driven leadscrew and a linear guide rail. With a lower pitch leadscrew and with a high pully ratio, the gantry 72 should not drop vertically with a power loss. This can be important since if the gantry 72 were to drop vertically with a power loss, it could damage (e.g. crush) the underlying mushrooms 25 or get stuck in the substrate. This is in contrast to using a braking mechanism that would be heavy and slow down performance. The gripper 70 is also visible in this view and includes a plurality of fingers 130 depending therefrom, which are described below. The gripper 70 controls not only the positioning of the gripper 70 but also the actuation of the fingers 130 to delicately pick the mushrooms 25.

The vision system rail 60 at the front of this view incorporates a portion of the channel 66 to accommodate the irrigation sprinklers and extends between opposite sides of the cover 64 and between a front pair of wheel assemblies 68. The battery rail 62 at the rear of this view also incorporates a portion of the channel 62 and extends between opposite sides of the cover 54 and a rear pair of wheel assemblies 68. An open area is created between the wheel assemblies 68 on each side of the harvester. This permits the gripper 70 to extend beyond the edges of the bed 12, e.g., to complete a harvesting operation by transferring a picked mushroom 25 outside of the bed 12 and to the transfer frame 26 of the packer 24. The wheel assemblies 68 also include brake mechanisms for controlling the position of the harvester 20 along the length of the growing bed 10.

The battery rail 62 contains all power-related mechanisms for the harvester 20 and contains a battery pack to enable the harvester 20 to be cordless. This avoids cords interfering with the growing bed when the cords are dragged over the mushrooms 25. The battery rail 62 also may include one or more battery charging ports for autonomous charging via the dock 53 on the lift 22. The battery charging port (not shown) is located on the underside of the battery rail 62 to align with the dock 53 such that when they are in proximity the magnetically latch on to each other and trigger charging. The battery rail 62 also includes network communications antenna to minimize interference from other components of the harvester 20 and can be configured to have swappable battery logic to allow for swapping the battery pack while the power is kept on. The battery rail 62 is positioned at the back of the harvester's frame and is positioned at a height to clear any possible mushroom fill level or tall mushrooms 25 (e.g., portabellas) and as noted above to include the channel 66 to clear the sprinkler heads above the harvester's frame.

With respect to the frame, the frame of the harvester 20 needs to fit in a very small/narrow space between the growing bed levels 12 while providing sufficient rigidity to support harvesting mushrooms 25 in an industrial setting. The frame should also have the flexibility to deal with high intolerance of the growing beds 10. In the configuration shown herein, the frame is designed to be tolerant of high compost fill-height and relatively tall mushrooms 25. To create the rigidity of the core frame precision dowels and alignment blocks can be used for jointing the frame components together. This can assist in preventing frame skewing, misalignments, and position intolerance in the lateral, longitudinal, and vertical directions.

The upper part of the reinforced frame can be used for control/power wiring channels and tracks to allow for unrestricted motion in the lower part of the frame. The upper part of the frame also contains the linear guides (as noted above) that the harvester 20 relies on for position reference and rigidity. The left side of the frame is used as the indexed side of the frame i.e., the mounting points on the left side are precise and have tight tolerances, while the right side of the frame has higher tolerance mounting points to support floating connections. This enables the required high-precision positioning of the gripper 70 even though the growing beds have high tolerances and variability. The frame can use aluminum and stainless-steel components for weight and food-safety considerations. Any plastic components can be chosen to be food-safe grade, while the mechanisms that normally require lubricant can be chosen to have self-lubricating properties. The harvester 20 can also utilize covers that cover most of the body allowing the automated harvester 20 to be wiped-down to comply with food-safety regulations along with providing the protective attributes mentioned above.

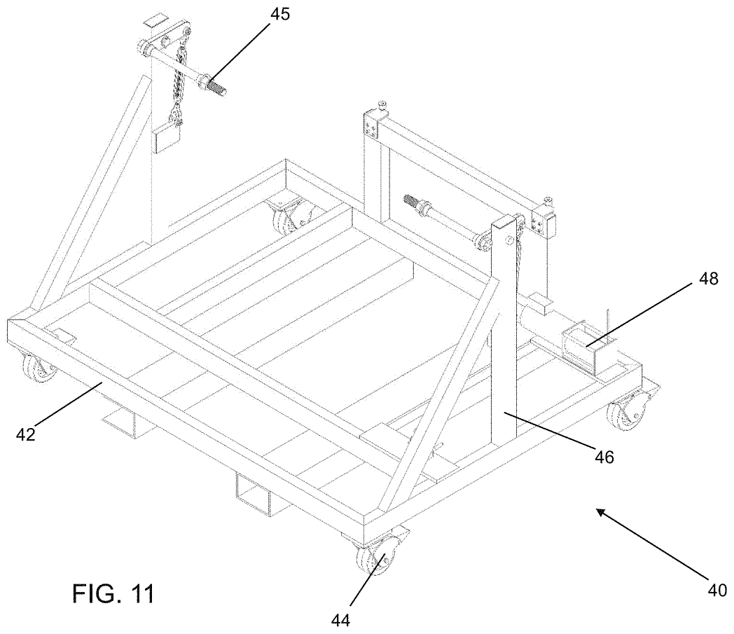

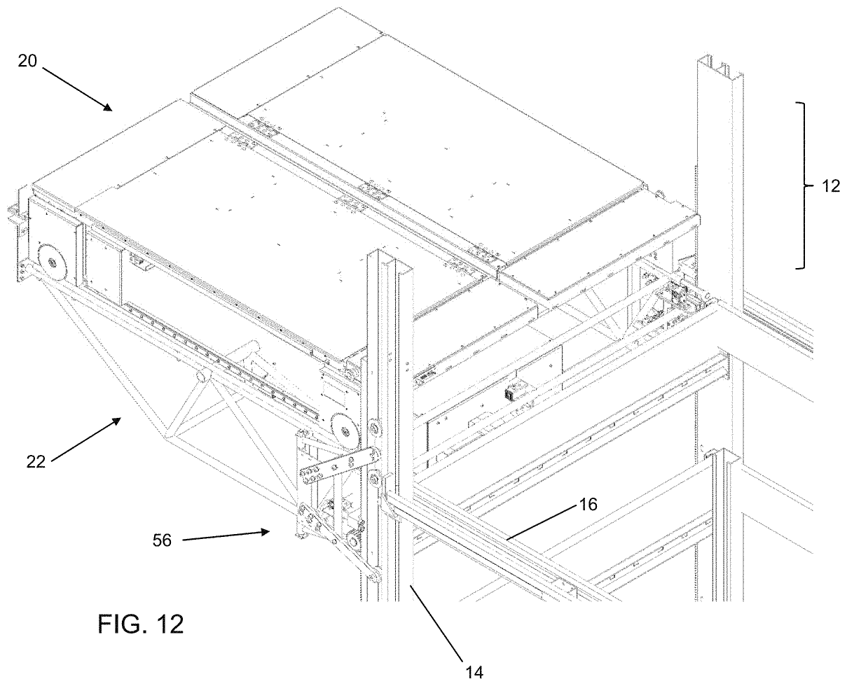

As shown in FIGS. 9 and 10, the harvester 20, lift 22 and carrier cart 40 are complementarily sized to permit the lift 22 to be loaded and unloaded from the cart 40 while supporting and carrying the harvester 20. The harvester 20 is therefore able to be transported along with the lift 22 to a growing bed 10, interface with the growing bed 10 and be lifted to a desired level 12 of the growing bed 10. As noted above, the lift 22 is temporarily attached to the growing bed 10 and this permits the carrier cart 40 to be removed and reused, for example to move another lifter 22 (with or without a harvester 20) within a growing operation. FIG. 11 shows the carrier cart 40 in isolation and provides a view of a pair of pins 45 that. As seen in FIG. 11, the lift 22 itself has a cylinder aligned perpendicular to the lift/harvester direction, which can be seen in FIG. 12. When the lift 22 is lowered down to the floor level of the bed 10, one can manually bring the cart 40 over, pull the pins 45 out, align the pin hole with the lifts' cylinders and then push the pins 45 back through both systems. The lift 22 then essentially pivots around these pins and is locked in position. To deal with miss-alignments when pinning the lift 22 to the cart 40, one can employ turnbuckles that you can be seen near the pins 45 in FIG. 11. The turnbuckles can be used to finely adjust and align the holes together before pinning.

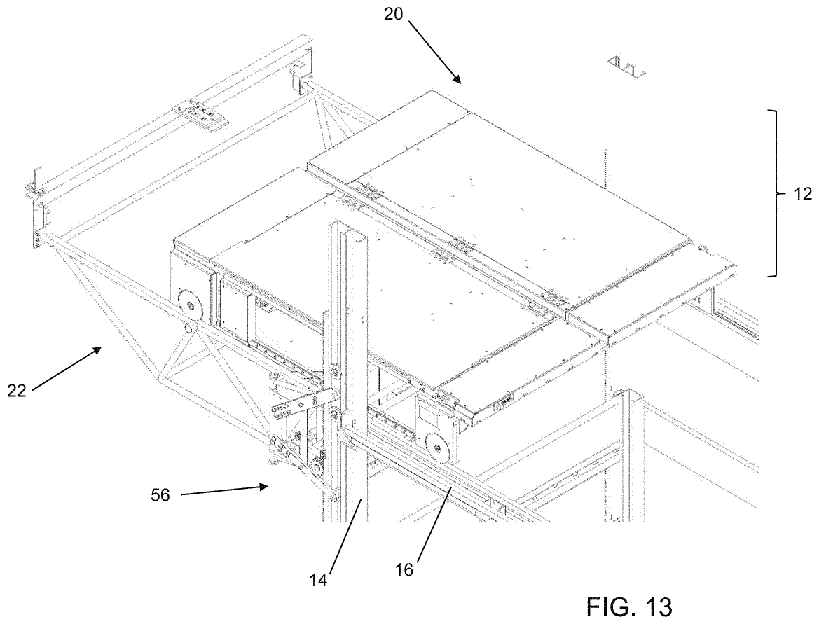

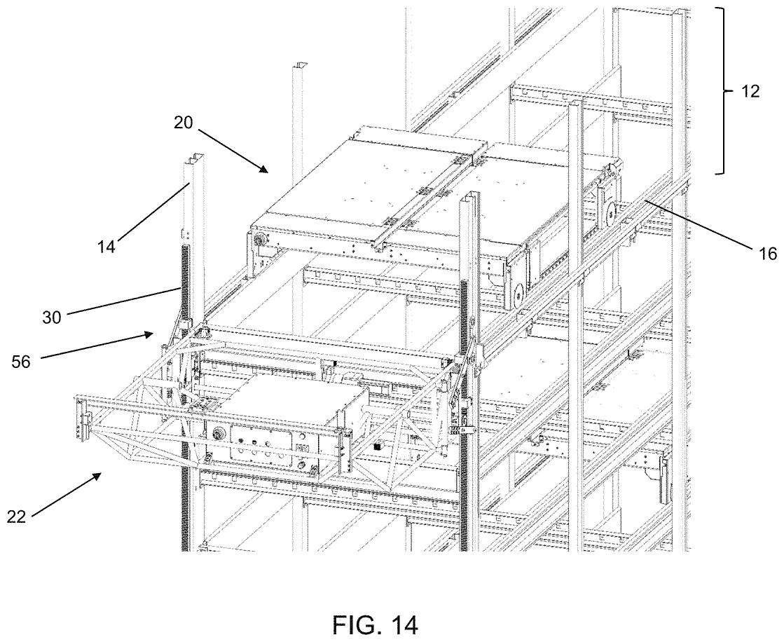

FIG. 12 illustrates the lift 22 attached to the vertical posts 14 of a growing bed 10 aligned with a particular level 12 of that bed 10. The lift 22 is attached using the roller assemblies 56 and can automatically detect the levels 12 of the bed 10 using optical sensors (e.g., proximity sensors) attached to the lift 22, and marker plates attached to each level 12, allowing for precise alignment of the lift 22 and the bed rails 16. FIG. 13 illustrates the harvester 20 driving from the lift 22 onto the bed 10, and FIG. 14 illustrates the harvester 20 fully deployed onto the level 12 of the bed 10 with the lift 22 being left behind in its aligned position. From there, the lift 22 can move to a different level 12 or return to the carrier cart 40 at the base of the bed 10. FIG. 14 also shows the roller assemblies 56 engaged with the racks 30 that have been installed along the posts 14 as described above.

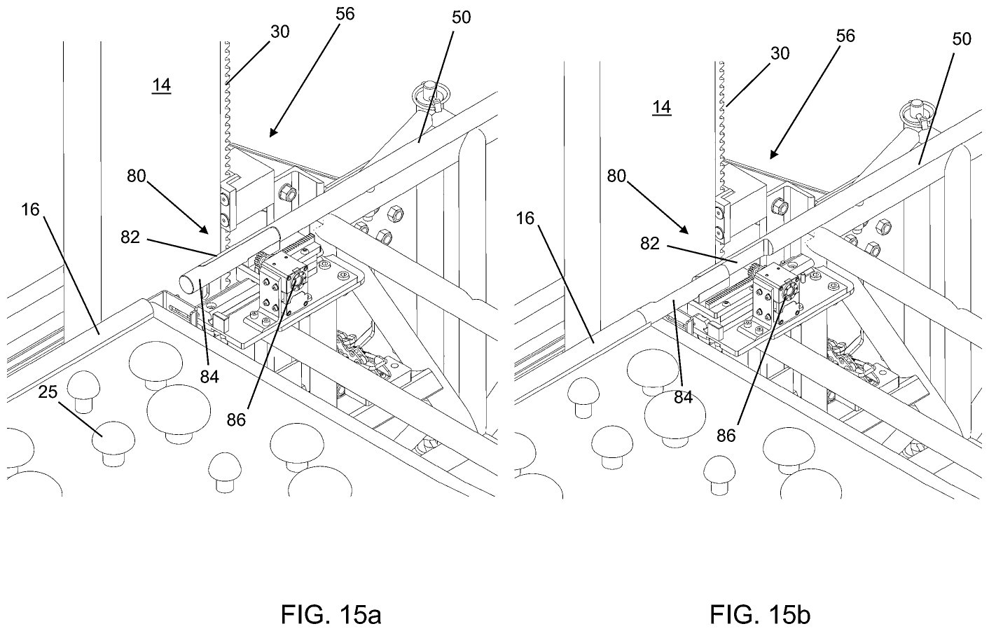

Due to the imperfect nature of the bed rails 16 and the geometry of the conventional infrastructure of the growing beds 10, the rails on the frame 50 of the lift 22 do not completely reach the bed rails 16. To provide a continuous rail between the lift 22 and the bed 10, a bridging mechanism 80 is included with the lift 22 adjacent each roller assembly 56. The bridging mechanism 80 is shown in FIGS. 15a and 15b and includes a retractable end 84 that extends and retracts from a modified post 82 extending from the lift frame 50. The retractable end 84 is driven to and from the bed rail 16 using an actuator 86. In FIG. 15a, a retracted position is shown and in FIG. 15b an extended position is shown in which the retractable end 84 has been extended by the actuator 86 to abut with the end of the bed rail 16. This creates a smooth harvester path from the lift 22 to the bed rail 16 and vice versa. The bridging mechanism 80 can be extended and retracted on demand using the actuator 86 to prevent collisions between the lift 22 and the beds 10 during level changes.

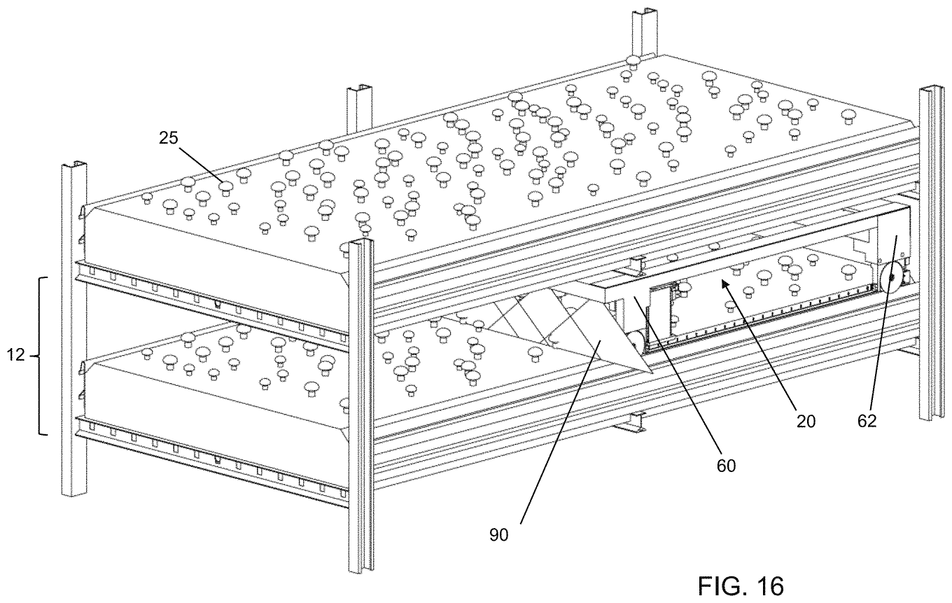

Once deployed onto a level 12 of the growing bed 10 the harvester 20 can begin scanning and picking operations. FIG. 16 illustrates the harvester 20 during a scanning operation. In this view it can be seen that a combined laser line 90 effectively sweeps over the mushrooms 25 to generate a 3D point cloud for further processing. That is, the physical configuration of the multiple scanners used by the vision rail 60 facilitates the scanning of mushrooms 25 within a constrained vertical space.

The vision system is supported by or contained within the vision system rail 60 and for ease of illustration the vision system rail 60 will be referred to below. The vision system rail 60 is located at the front of the harvester's frame since the harvester 20 is configured to only need to move forward after scanning mushrooms 25 to align the gripper workspace with the scanned data. It may be noted that if the harvester 20 moves forward and backward after scanning, the scan data could become invalid since reversing wheel movement can accumulate position errors through backlash or wheel slippage on the rails 16.

The position of the vision system rail 60 relative to the gripper's workspace is important for successful picking of large bed sections at once. The vertical positioning of the vision system rail 60 is also important since it needs to clear all obstacles in the bed, similar to the battery rail 62 as discussed above. However, the vision system rail 60 also needs to allow for the largest possible height difference between the 3D scanners of the vision system and the mushroom 25 growing from the substrate. The width of the vision system rail 60 is also maximized to allow the scanners to capture not just the growing bed, but also a distance beyond the rails 16 (e.g., 300 mm of the 375 mm outside both the left and right side of the bed) to enable the detection of a drop-off location and for post detection.

The vision system rail 60 can also include rail reinforcements to generate rigidity due to the very narrow profile. In this example configuration, the vision system rail 60 supports a set of six 3D scanners, each having a pair of camera apertures (for capturing images below the rail 60) and a laser slot for permitting a laser line to project from the vision system rail 60 onto the mushrooms 25 below.

The camera holes can be sealed with optical-grade clear panels. Since the vision system rail 60 is enclosed, the electronics within it can be passively cooled using the thick and large aluminum surface of the vision system rail 60 to prevent the use of active cooling (e.g., fans) thus preventing humidity from entering the vision system rail 60 during cooling. The vision system rail 60 can have its multiple 3D scanners aligned in one straight line to effectively form a combined (e.g., 1.9 m long) line scanner within tightly constrained vertical spaces, while achieving sub-millimeter accuracy and very high data throughput. The vision system rail 60 can also generate color information that is overplayed on a 3D point cloud allowing for real-time disease detection, mushroom quality and type identification. The vision system rail 60 can also include external air temperature and humidity sensors for the grow room environment as well as contactless soil temperature sensors.

FIG. 16 illustrates how the multiple 3D scanners can work with each other to scan the entire width of the bed (or more) with only a limited amount of vertical space. The “Laser Scanner Span Angle” (LSPAN) in an example configuration can equal 100 degrees and the “Laser Scanner Line Width” (LFOV) in this example configuration equals 600 mm. The laser line overlap in this example configuration equals 325 mm, and the distance between the scanners and the substrate in this example configuration equals 240 mm. The minimum scan distance in this example configuration equals 100 mm. It can be appreciated that other distances between scanners, etc. can be used depending on the implementation. The example values given herein can be used to maximize visibility of the mushrooms 25 and their stems.

The different sizes of mushrooms 25 illustrated in FIG. 16 also highlight the importance of using the disclosed configuration.

First, this shows that taller mushrooms 25 can occlude smaller mushrooms 25. That is, two neighboring mushrooms 25 can create a shadow on a smaller mushroom 25, however, the laser line 90 above accounts for such a potential problem. Therefore, by using multiple lasers, the smaller mushrooms 25 are now visible. Second, this view shows that a mushroom 25 that is at the edge of the scanner (or under a large angle) can occlude itself, as such it's important to be able to see all sides of the mushrooms 25 for adequate detection. Third, having the scanner close to the edge of the bed allows the scanner to scan the vertical posts 14 to prevent the gripper 70 from hitting it while telescoping, but also allows the vision system to scan for mushrooms 25 on the very edge of the bed, and for other objects of interest that are outside the bed to be detected (e.g., a mushroom delivery platform).

As a result of this configuration (with the above example values) a 1.9 meter long laser line scanner is created, that has the ability to scan objects even when other objects are occluding it, with a minimum scan distance of 100 mm (for full scanning coverage in this configuration). Therefore, the vision system can fit in very tight spaces that require up close scanning. The rate at which the scanners scan can be between 1-150 lines per second where a line includes 7700 points that cover the 1.9 meters span (including overlapping points). The scanner's resolution in this example can be 0.25 mm in XYZ after processing. The resolution/fps/length of the scanner line can be configured for a vast range of applications that require either precision, or speed, or overlapping region, or length of scanner, etc. That is, one can simply modify the parameters listed above and select sensors having different resolutions.

The vision system can scan a section of the bed (e.g., variable length of section up to 800 mm), then move forward into a picking position, and pick mushrooms 25 until no more target mushrooms 25 are available. The harvester 20 can repeat this process for the rest of the bed. The harvester 20 does not need to sequentially work its way from start to end, it can first perform a global scan, then dynamically build a picking schedule based on where the target mushrooms 25 are along the bed, and then execute in that order to maximize effectiveness and to reduce chances of mushrooms 25 growing larger than target size. Any suitable logic can be developed and executed to choose a suitable picking schedule as described in greater detail below.

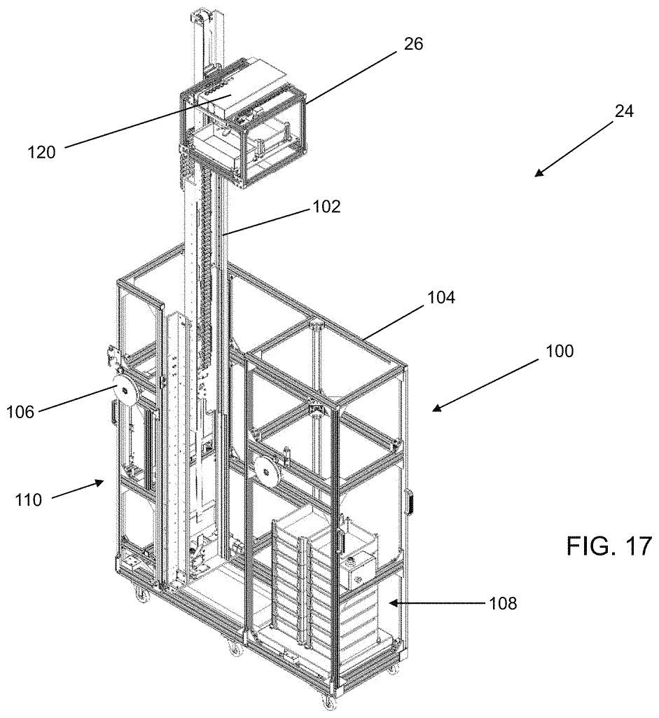

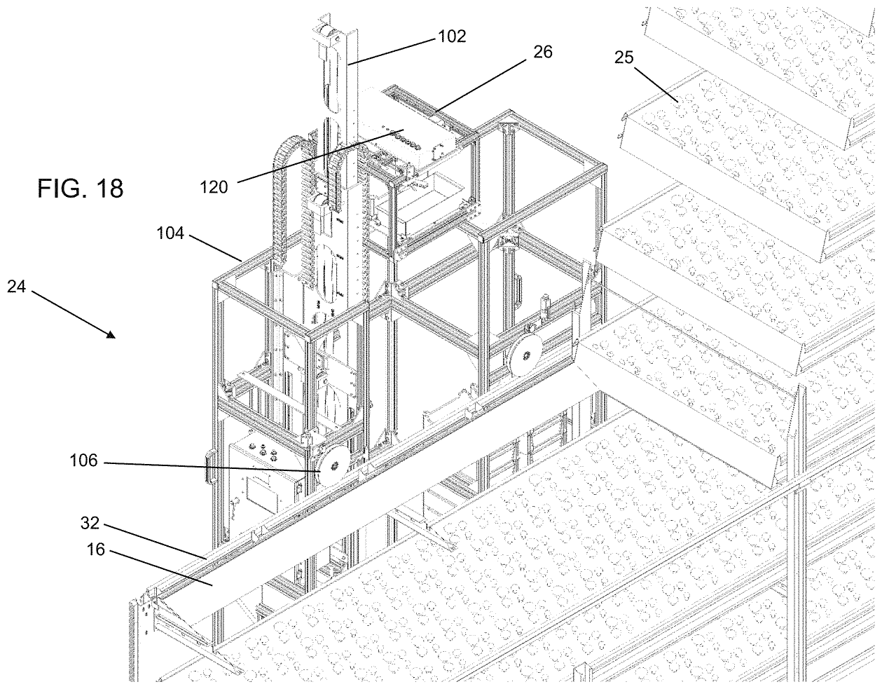

Referring now to FIG. 17, the packer 24 is shown in isolation. The packer 24 is designed to serve the purpose of receiving mushrooms 25 from the harvester 20, cutting their stems, and packing them into boxes while being weighed. The packer 24 includes a trolley 100 that is attached to one side or the other of the growing bed 10. In this way, the packer 24 is able to operate (i.e., receive/cut/pack mushrooms 25 transferred from the harvester 20) at any location of the entire bed 10. The trolley 100 includes a frame 104 that supports a telescopic arm 102. The telescopic arm 102 is used to elevate the transfer frame 26 to position it adjacent the various levels 12 of the growing bed 10. Attached to the frame 104 are a pair of wheels 106 that are sized and positioned to roll along the packer rail 32 that is attached to a side rail 16 of the growing bed 10. This interaction between the packer 24 and the packer rail 32 is shown in FIG. 18.

The packer 24 frame 104 defines a discard area 110 at one end and a box management area 108 at the other end. The telescopic arm 102 is positioned between the discard area 110 and the box management area 108 to position the transfer frame 26 adjacent either area 108, 110 to permit discard bins and mushroom packing boxes to be loaded and unloaded as the mushrooms 25 are harvested, transferred, cut, packed and weighed. The frame 104 can therefore be configured to include an internal channel or cutaway to permit movement of the transfer frame 26 to levels 12 adjacent the frame 104. It can be appreciated that the telescopic arm 102 can employ any suitable telescoping mechanism such as the one shown in FIGS. 17 and 18. This type of telescoping system is used to be able to reach the very top of the bed 10 (level 7), while also being able to reach the very bottom of the bed 10 (level 1). Level 1 is only about 400 mm off the floor. This is hard to accomplish using a conventional lifting system, in such tight space constraints. For example, a scissor lift has a large span, but it requires a lot of infrastructure especially towards the bottom when it compresses. This telescoping arm 102 in this example is a 4 stage, single motor, belt driven, span of 4.5 m, and takes up very minimal infrastructure/space. Each stage is linked together using a set of linear guides and roller carriages, making this design relatively simple and robust. This telescoping arm 102 is very rigid which is required when dealing with high speed components (in packing cell) at high heights and can also quickly telescope up and down to meet industrial requirements (i.e., keep up with mushroom growth, since every second counts).

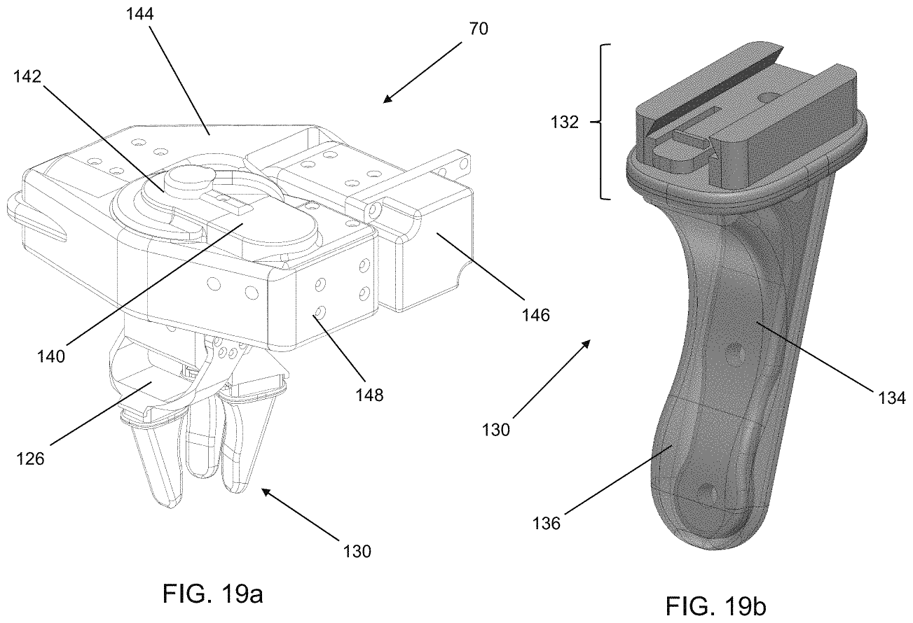

Also shown in FIGS. 17 and 18 is a transfer device 120 that is positioned within the transfer frame 26 and is controlled to interact with the gripper 70 to allow the harvester 20 to transfer a mushroom 25 that has been harvested by the gripper 70 to the packer 24. In this way, the harvester 20 can move on to the next mushroom 25 in a harvesting schedule while a stem cutter (described below) can remove the stem, drop the stem in a discard bin, and place the mushroom 25 in a packing bin. FIG. 19a provides a perspective view of the gripper 70 in isolation.

Referring to FIG. 19a, the gripper 70 in this example incorporates four degrees of freedom and can perform full hemispherical motion plus is able to open and close a set of fingers 130. It may be noted that this is the least number of degrees of freedom required to successfully pick and manipulate mushrooms 25 and was modelled after how humans pick mushrooms 25. In conjunction with movement along the axes of the gantry 72 and the operation of the fingers 130, the gripper 70 can push, pull, twist, tilt, hold, release, and move mushrooms 25 very gently. The gripper 70 is load sensitive and thus can feel pressure as it is being applied to the mushrooms 25 so as to not crush them. A perspective view of a finger 130 in isolation is shown in FIG. 19b.

The gripper 70 is connected to the gantry 72 and is controlled to execute advanced manoeuvres to replicate human picking motions. To achieve this, the gripper's four degrees of freedom (i.e., multi-turn spherical manipulator and open/close fingers 130) have a narrow profile in all directions to prevent gripper contact with neighbouring mushrooms 25 during a pick. The gripper motor controls and power wiring can be daisy chained to allow for compactness and simplicity of wiring. The gripper 70 is capable of tilting, twisting, pushing, pulling, and carrying a mushroom 25 using the specially designed fingers 130 that attach to the gripper 70.

The fingers 130 attach to the gripper 70 in a specific configuration (e.g., thumb at 0 degrees, left index finger at −165 degrees, right index finger at +165 degrees). This configuration was chosen as the optimal and minimal required number of contact points while generating a geometrical lock on the mushroom 25 for manipulation in any direction without the reliance on finger friction. The mechanism 126 for attaching the fingers 130 to the gripper 70 can be adjustable to allow for +/−20 degree changes in their position as well as how close the index fingers 130 are to the thumb finger. This allows the gripper 70 to target mushroom 25 sizes that differ by 100 mm using the same fingers 130 and gripper 70.

The fingers 130 can be configured to slide on to the mechanism 126 on to a mounting portion of the gripper 70 from the outside towards the center and can be ratcheted so they can only slide forwards. This interfacing mechanism 132 on the finger 130 is shown in FIG. 19b. The attachment mechanisms 126, 132 help with easily swapping out fingers 130 for new ones, while remaining stiffness in the assembly when mushrooms 25 apply force in the opposite direction. The gripper 70 has the ability to sense closing force on the mushroom 25 to prevent damaging the mushroom 25 during picking effectively mimicking “human force sensing” when picking mushrooms 25.

Referring to FIG. 19b, the finger 130 has been designed to include no moving components by using a metal backbone 134 and a silicone cover 136 that together are compliant to the shape of a mushroom 25 without damaging the mushroom 25. This design improves the surface area contact and mimics the human finger. The metal backbone 134 is advantageous in that it can overcome issues with mechanical linkages since the backbone 134 is designed to be strong, ridged, flat, and thin. The silicone sock 136 is designed to be soft and compliant, which will conform its shape to the mushroom 25 during a grasp, increasing surface area and grip of the mushroom 25, regardless of mushroom shape. That is, the design of the finger 130 is similar to the anatomy of the human finger, namely with bone and skin. The cross-section of the finger 130 can be relatively narrow, which allows the fingers 130 to fit in narrow gaps between the mushrooms 25 thus damaging fewer mushrooms and allowing the gripper 70 to pick more mushrooms 25 that were previously ungraspable due to risk of collision.

The silicon socks 136 can also extend the life of the fingers 130 and provide cleanliness, food-safety, and create a soft barrier between the mushroom's surface and the finger surface.

If the finger 130 is to touch a neighbouring mushroom 25 during finger insertion, the silicon sock 136 would contact the mushroom 25 and is compliant thus not damaging the mushroom's delicate surface. The finger 130 and its sock 136 is also intended to be replaced often, which can be done to match a human's glove replacement levels to satisfy established food-safety regulations in the industry. The socks 136 can also be coated to reduce the possibility of disease build-up, as well as irradiated using UVC LED light array as a germicide while in operation to prevent the spreading of disease from one mushroom 25 to another.

As seen in FIG. 19a, the gripper 70 can include a grasping servo 142, three primary servos 140, 144, 146 and a body 148. Joint rotation axes of the gripper 70 are arranged orthogonally to each other and intersect in a single point. The grasping servo 142 is responsible for actuating the fingers 130 and for sensing grasping force feedback. The primary servos 140, 144, 146 can be used for independent actuation of joints to achieve the various orientation angles described above, for movements such as tilting, twisting, etc.

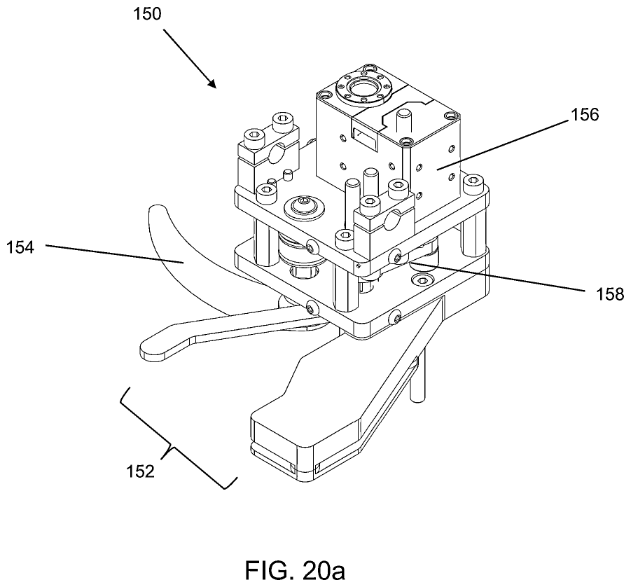

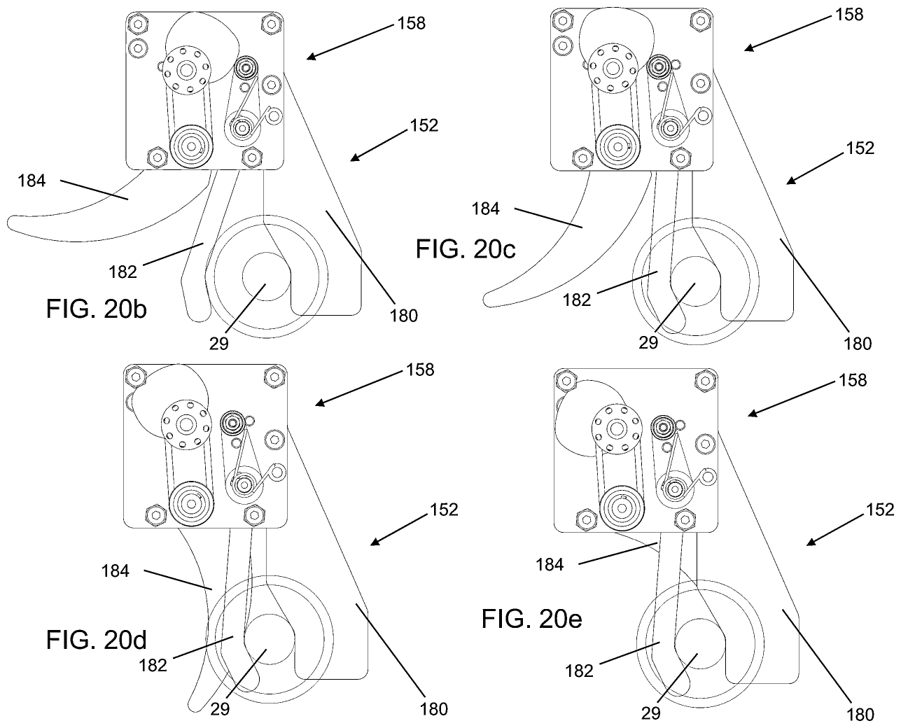

FIG. 20a provides a perspective view of a stem cutter 150 of the transfer device 120 in isolation. The stem cutter 150 includes a stem gripper 152 and a stem cutting blade 154 that rotates relative to the stem gripper 152 to cut a stem from a mushroom 25 that is being held by the gripper 152. The stem cutter 150 also includes a motor 156 and cam-driven mechanism 158 to operate the receiving, grabbing, and cutting of the mushroom stem as illustrated in FIGS. 20b-20e.

In the sequence shown in FIGS. 20b-20e, it can be seen that the blade 184 is directly coupled with the motor 156, while the stem gripper finger 182 is partially coupled to the motor 156 via the cam mechanism 158 and a torsion spring. The torsion spring keeps the gripper finger's cam follower pressed up against the cam in certain ranges of motion, unless in the range where a mushroom stem is expected to be. In this range, the cam will decouple from the follower and allow the torsion spring to take over and apply a force on the mushroom stem, keeping it in place for the cut. For the release of the mushroom 25, the direction of the cam is reversed, which overpowers the torsion spring, opening the finger 182 and thus releasing the mushroom 25.

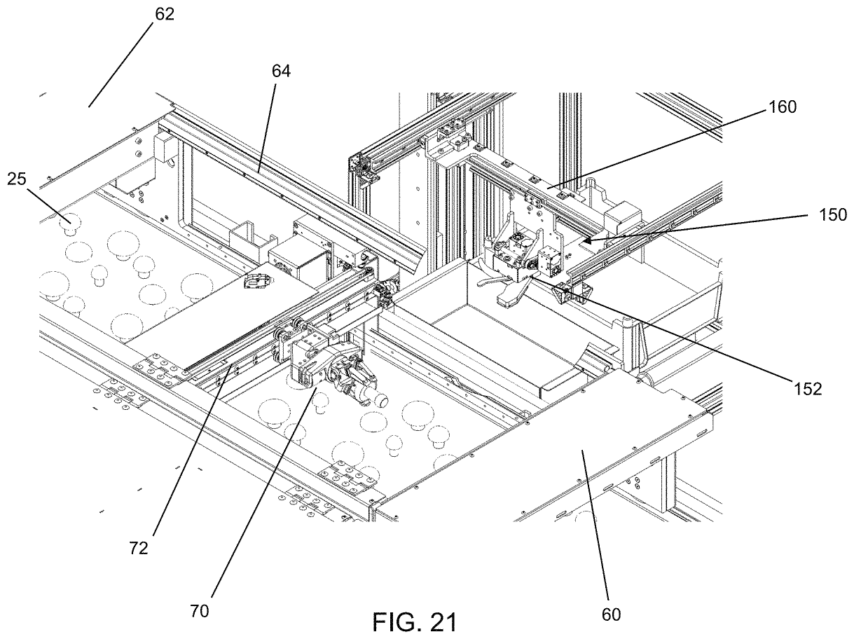

By using the stem cutter 150, the packer 24 has the ability to receive mushrooms 25 being transferred from the harvester 20 and cut off the undesirable parts of the stems. The stem cutter 150 is designed to reliably receive mushrooms 25 being transferred from the harvester 20 to the packer 24 as will be illustrated in FIGS. 21-28 described below.

The stem cutter 150 can tolerate many different mushroom sizes, shapes, and deformities e.g., mushroom clusters (multiple mushrooms 25 connected to the same stem) being transferred by dynamically adjusting its receiving geometry and position. Once the mushroom 25 is transferred from the harvester 20 to the packer 24, the mushroom 25 is then grabbed by the stem using the stem gripper 152.

The stem gripper 152 holds the entire mushroom 25 stable for both the purpose of cutting the stem using the blade 154 and manipulating the mushroom's position for precision packing, all without damage to the cap. The by-product of the cut (i.e., the undesirable piece of the stem that was cut off) is dropped into a discard bin. The stem cutter's depth of cut can be adjusted manually or automatically to allow for stem length control. The stem cutter 150 is attached to a packing cell gantry 160 as shown in FIG. 21, allowing the freshly cut mushroom 25 to be manipulated and moved to any position within the transfer frame 26. The stem cutter 150 is designed primarily for precision packing but can also be used to discard unwanted mushrooms 25 instead of packing them.

Referring now to FIG. 21, the gripper 70 is shown after having picked a mushroom 25 and in the process of transferring the mushroom 25 to the stem gripper 152. In this view the cover 64 and a portion of the upper rail 65 are removed for ease of illustration. In this view it can be seen that the fingers 130 are inserted around the mushroom 25 so as to carefully avoid contact with neighboring mushrooms 25 during the picking operation. It can be appreciated that the harvester 20 can be programmed to allow for slight contact, which can be an adjustable parameter. It can also be appreciated that the gripper's servos 160-166 can begin closing (actuating) the fingers 130 over the mushroom 25. When contact is formed in conjunction with finger actuation, the fingers 130 begin conforming around the mushroom 25. That is, if there was no mushroom surface to interact with, the finger's tips would remain straight. In this way the backbone 134 is compliant and bends such that a “tip” portion of the fingers 130 is located on the underside of the cap of the mushroom 25, which is an acceptable area to create slight damage (while the intention is to ideally have zero damage). As such, if any damage was to occur (unintentionally), it would occur on the bottom of the cap.

With the backbone 134 deformed such that its tips are positioned under the mushroom cap, the plurality of fingers 130 (e.g., the three fingers 130 shown in FIG. 19a) create a geometrical lock with the mushroom 25 preventing it from slipping out while being manipulated. The gripper 70 can be manipulated to perform a tilt/twist/push/pull action (or a different combination of those actions) to the mushroom 25 towards as much empty space as is available, so as to separate the mushroom stem from the substrate without damaging neighboring mushrooms 25 or hitting other obstacles. The gripper 70 can also be manipulated to provide a safe transport position for the mushroom 25 that is out of the way of the other unpicked mushrooms 25. For example, some taller mushrooms 25 may end up with a horizontal transport position to reduce the likelihood of hitting anything while travelling to a drop-off location.

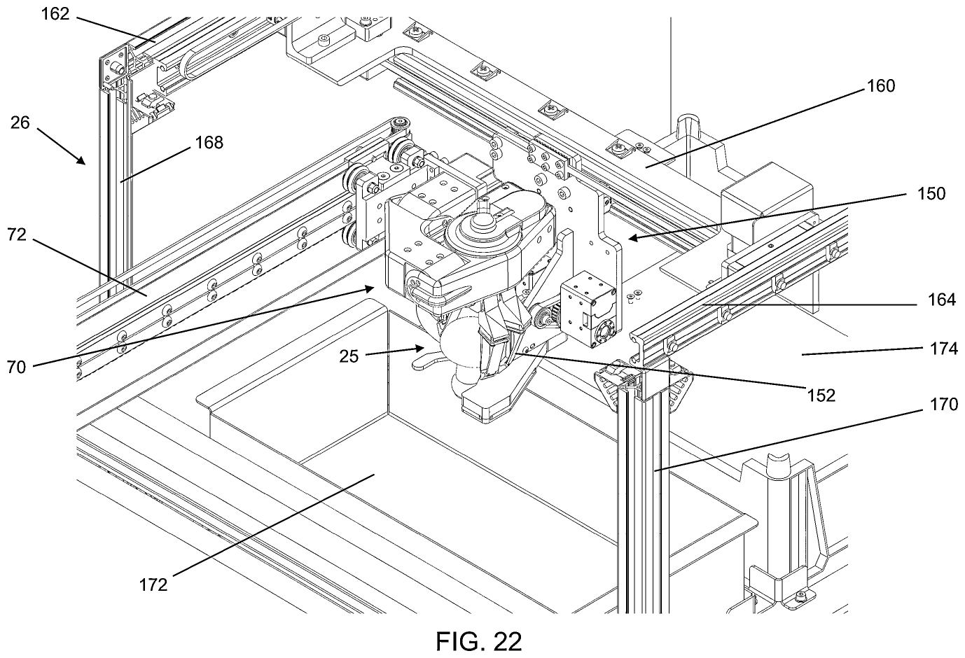

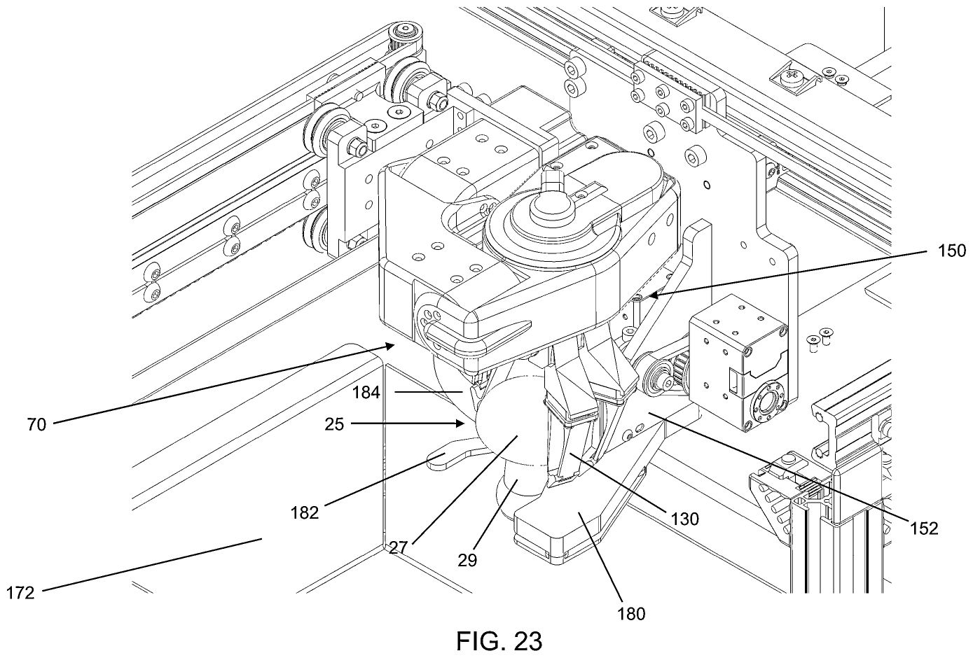

Referring now to FIGS. 22 and 23, a transfer between the picker 70 and the stem cutter 150 is shown. The gantry 72 extends beyond the sides of the bed 10 to permit the picker 70 to align with the stem cutter 150 in the transfer frame 26. Specifically, the picker 70 is aligned above the stem gripper 152 to permit the fingers 130 of the picker 70 to release the mushroom 25 as the stem gripper 152 grips the mushroom 25. As visible in FIG. 22, the packing cell gantry 160 spans between lateral frame rails 162, 164 that are supported above a discard bin 172 and a packing bin 174 by vertical posts 168, 170. As noted above, the stem cutter 150 can move laterally along the packing cell gantry 160 and it can be seen that the gantry 160 moves in the fore and aft directions within the transfer frame 26 along the lateral frame rails 162, 164. In the enlarged view of FIG. 23 the stem gripper 150 is shown in greater detail, with a fixed finger 180, a rotatable finger 182 and a blade 184 that rotates independently of the rotatable finger 182. The picker 70 positions the mushroom 25 such that the cap 27 of the mushroom 25 is above the fingers 180, 182 and the stem 29 of the mushroom 25 is between the fingers 180, 182 such that rotating the rotatable finger 182 holds the stem 29 of the mushroom 25 against the fixed finger 180. The picker's fingers 130 may then release the mushroom 25 to permit the picker 70 to move out of the transfer frame 26 and to pick the next mushroom 25. The stem cutter 150 can be operated as shown in FIGS. 20b-20e described above. That is, both the blade 184 and finger 182 are driven by the same motor, but when the cam mechanism moves to a certain range, a torsion spring takes over the finger 182 and applies a constant force to the stem 29, holding the stem in position, and essentially acting as if it is decoupled from the motor 156. As the cam driven mechanism 158 continues, the blade 184 continues rotating and eventually cuts the stem 29. When the mushroom 25 is to be released, the cam mechanism 158 (and blade 184) are rotated back to the range where 182 is not controlled by the torsion spring anymore, thus forcing finger 182 open to release the mushroom 25.

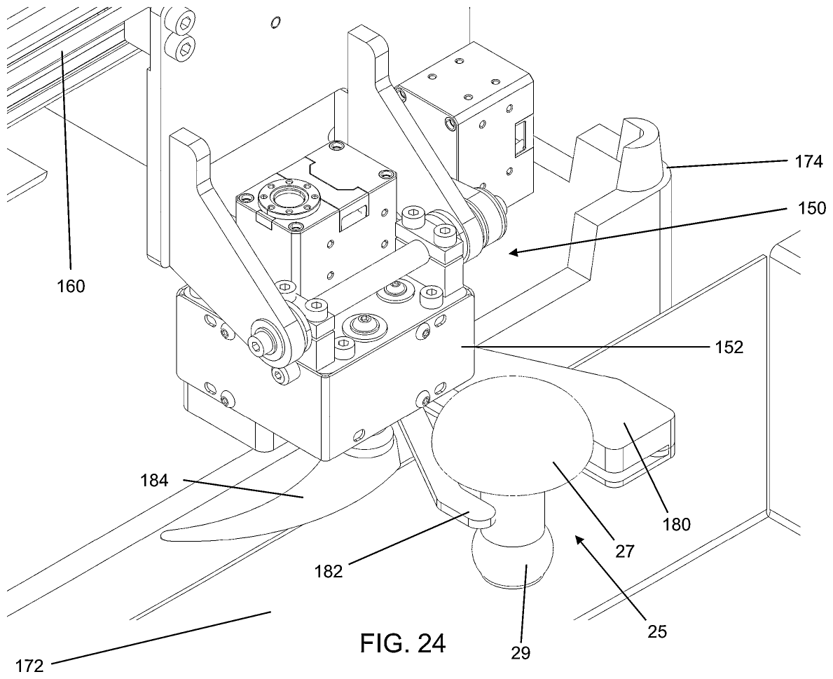

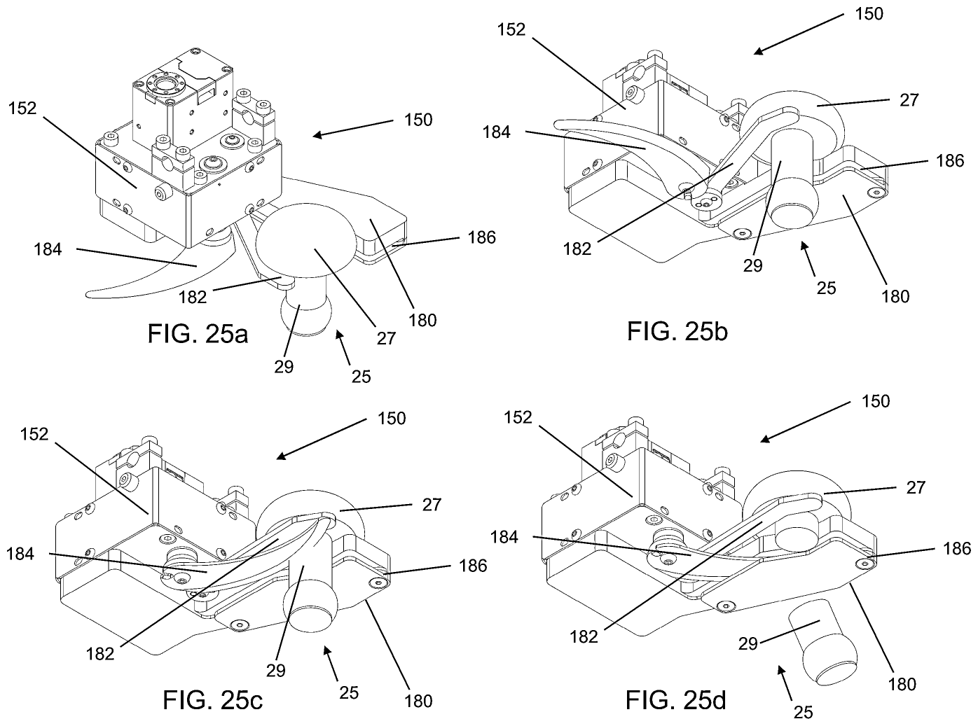

FIG. 24 illustrates the stem cutter 150 after the transfer has been completed. The stem cutter 150 can include at least one servo motor to permit the stem gripper 152 to be tilted towards or away from the discard bin 172 or packing bin 174 as illustrated below. The stem gripper 152 holds the entire mushroom 25 stable for both the purpose of cutting the stem 29 and manipulating the mushroom's position for precision packing, all without damaging the cap 27. The stem cutting operation is shown in the series of images shown in FIGS. 25a-25d. FIG. 25a shows the stem cutter 150 as positioned in FIG. 24 but in isolation. FIG. 25b illustrates the stem cutter 150 in this position but from below to illustrate the amount of stem 29 that extends below the fingers 180, 182 of the stem gripper 152. The exposed stem 29 is held firmly as noted above, to keep the mushroom 25 stable for the cutting action depicted in FIG. 25c. It can be seen that the blade 184 rotates towards the mushroom 25 and severs the stem 29 at a point that is aligned with the blade's plane of rotation. The mushroom cap 27 continues to be held by the stem gripper 152 above the fingers 180, 182 while the remaining portion of the stem 29 falls away into the discard bin 172 below.

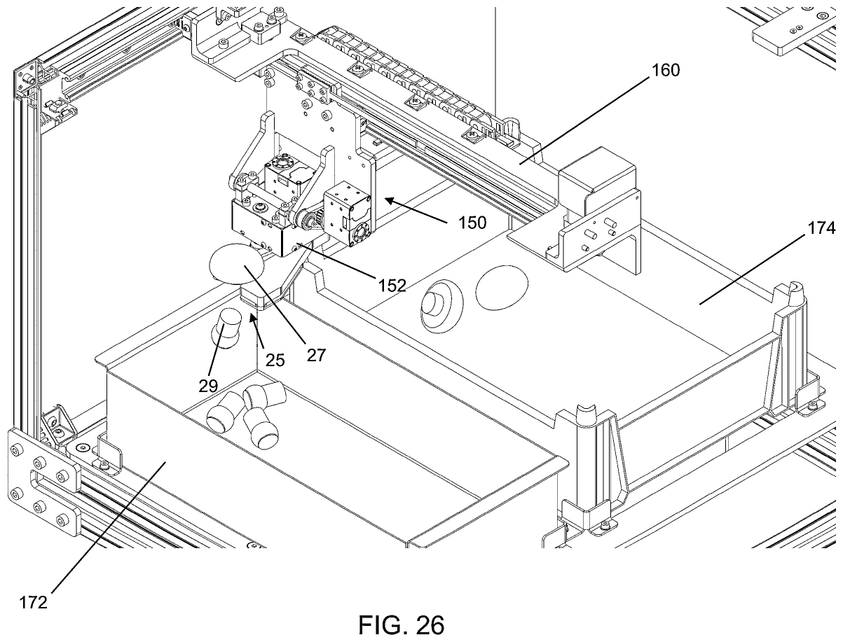

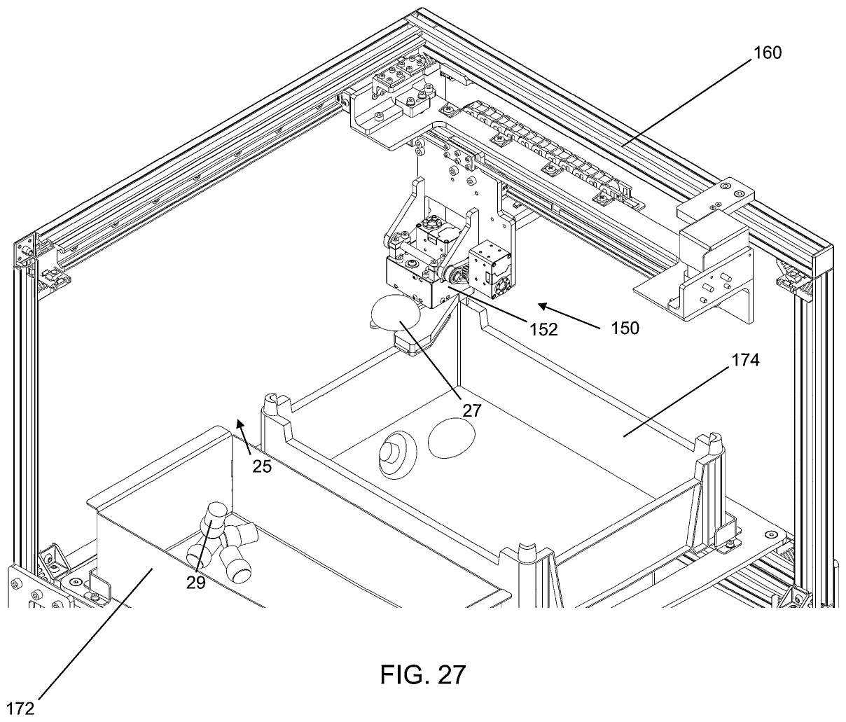

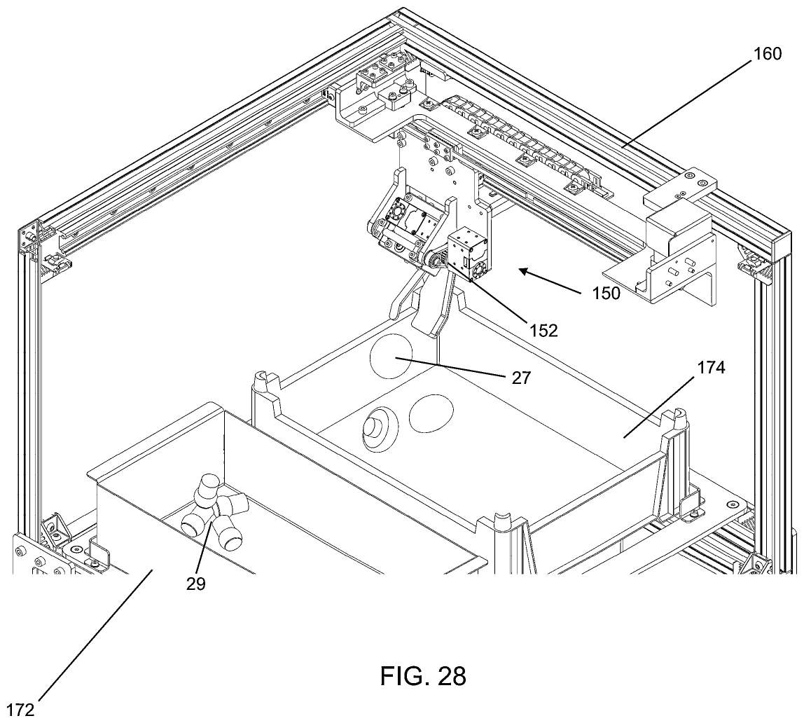

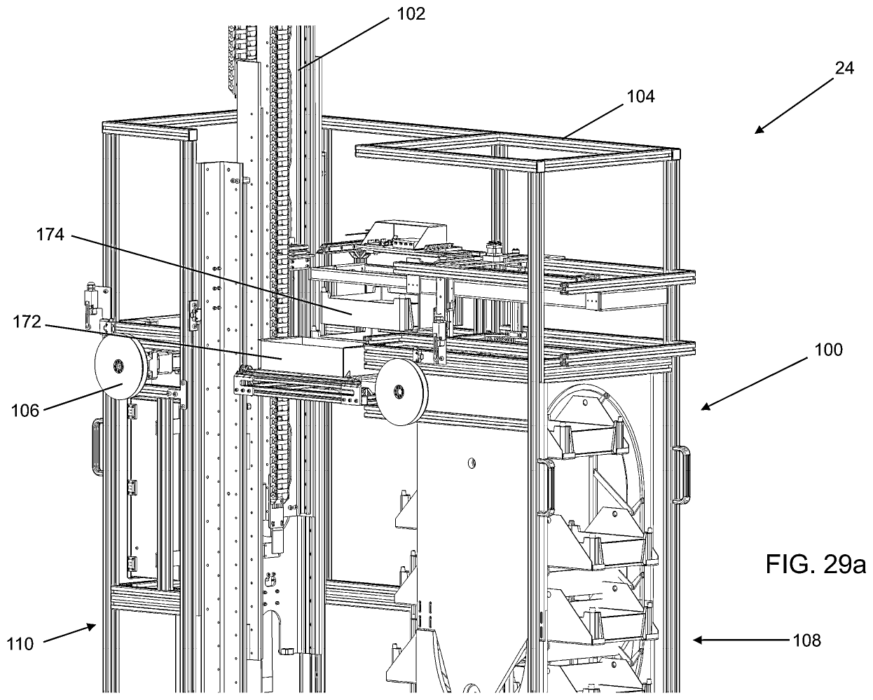

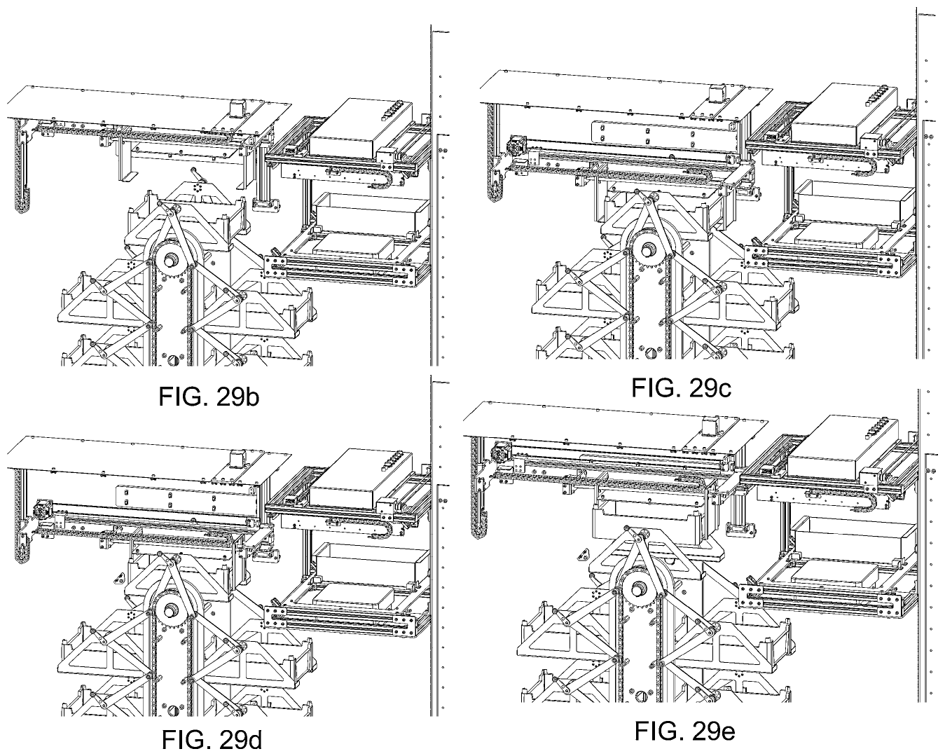

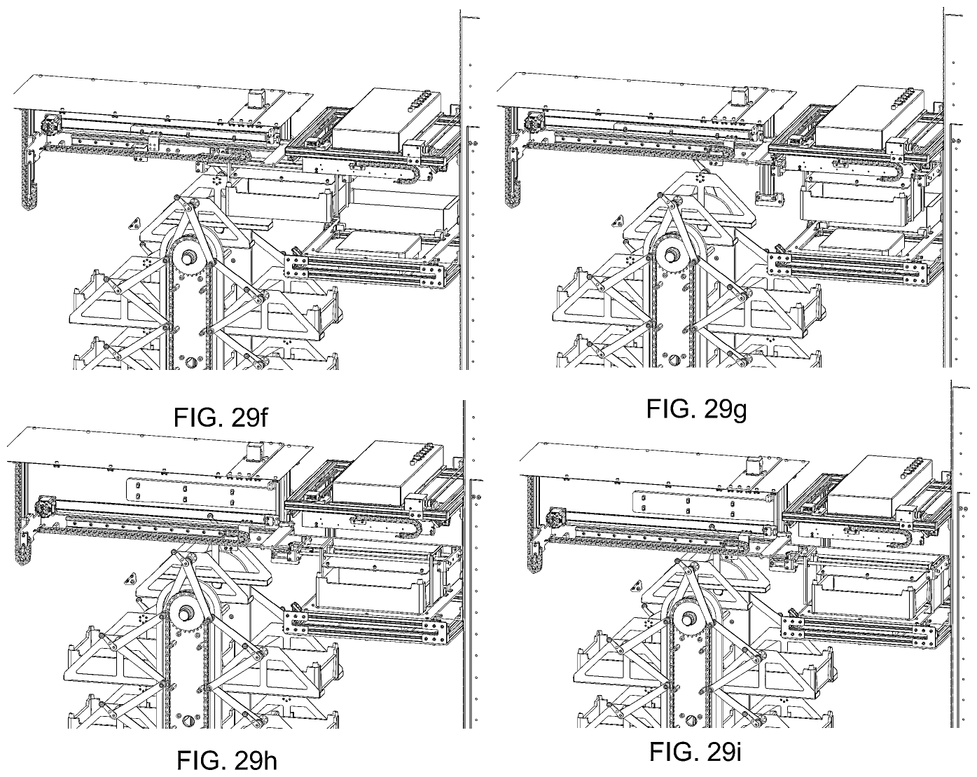

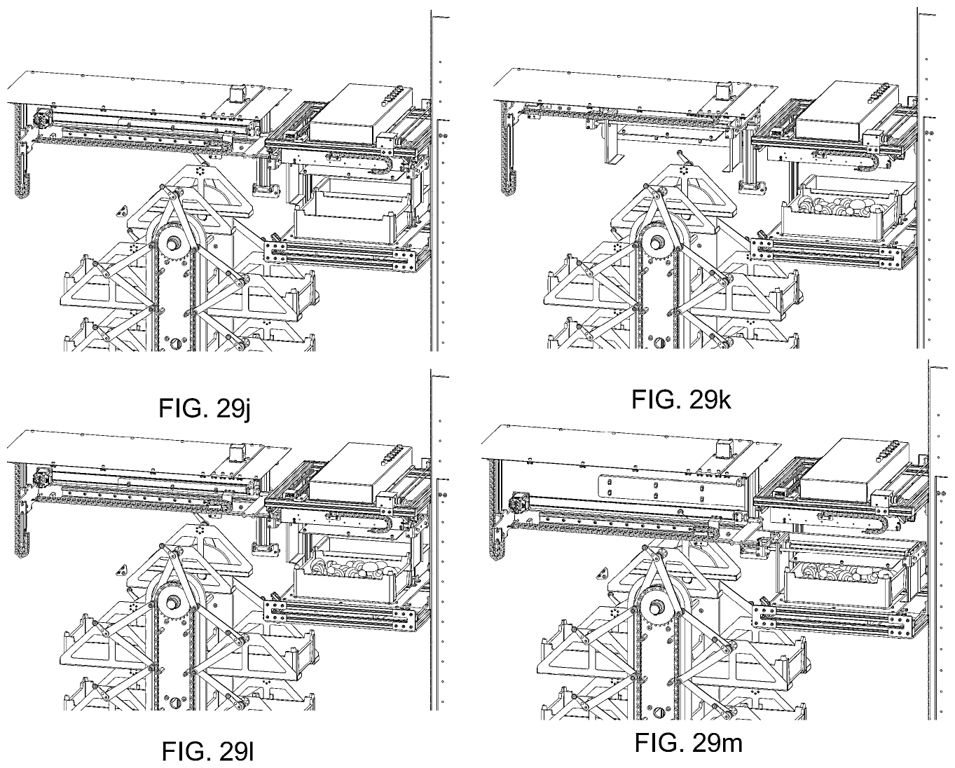

The cutting action shown in the series of images of FIGS. 25a-25d is shown in FIG. 26 in action, wherein the stem 29 drops into the discard bin 172. Referring next to FIG. 27, after cutting and discarding of the stem 29, the packing cell gantry 160 moves the stem cutter 150 into alignment with the packing bin 174 to allow the mushroom cap 27 to be released from the stem gripper 150 as shown in FIG. 28 and to be placed into the packing bin 174.

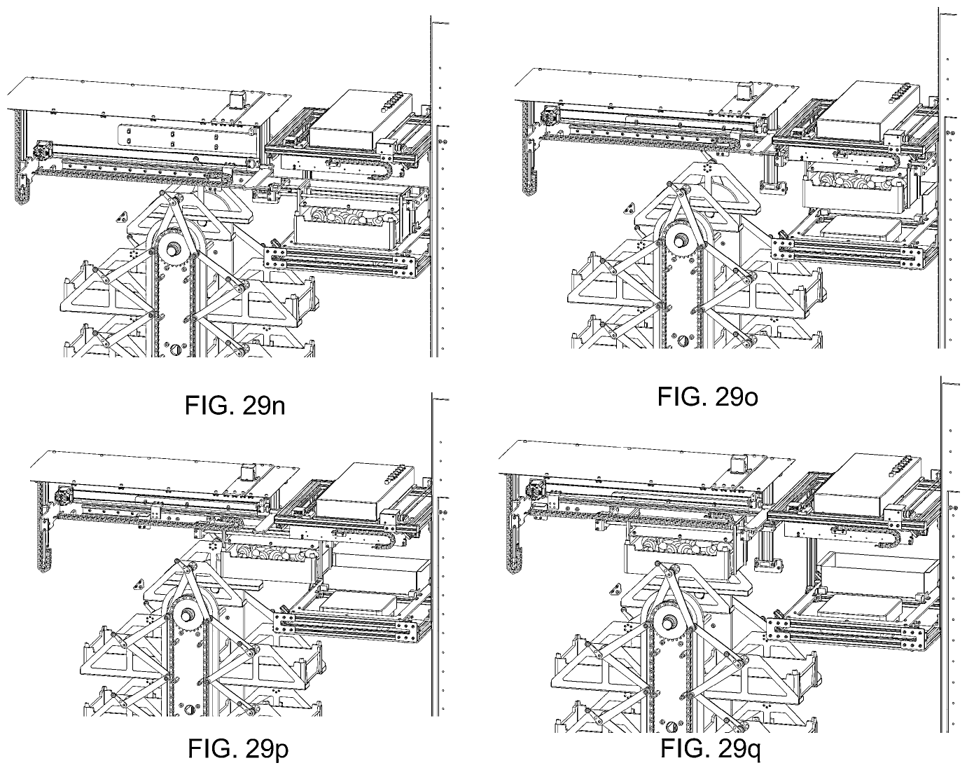

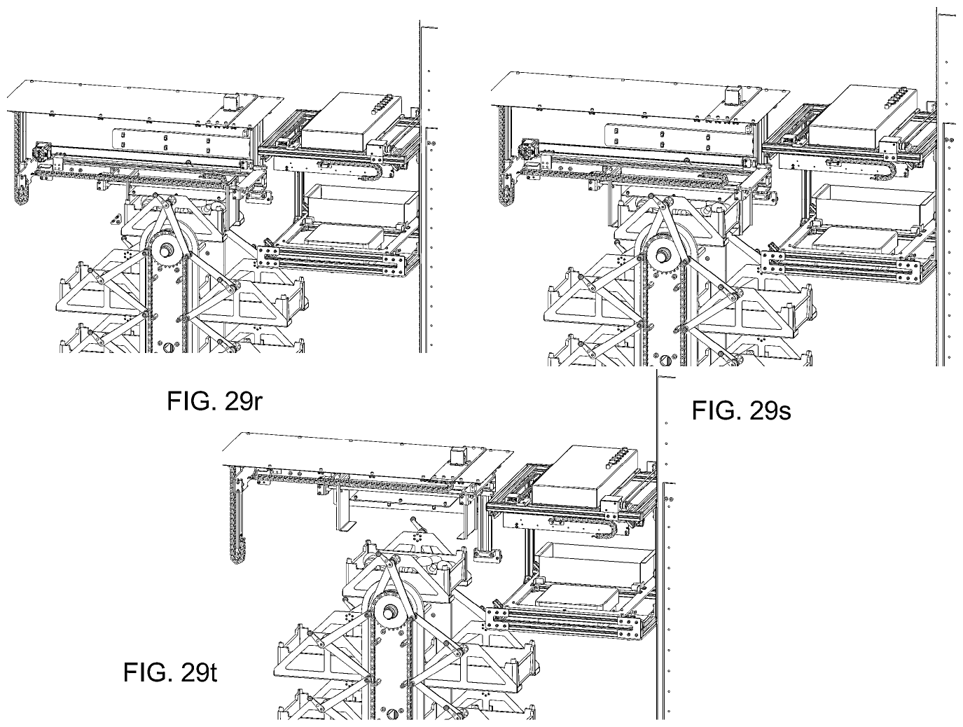

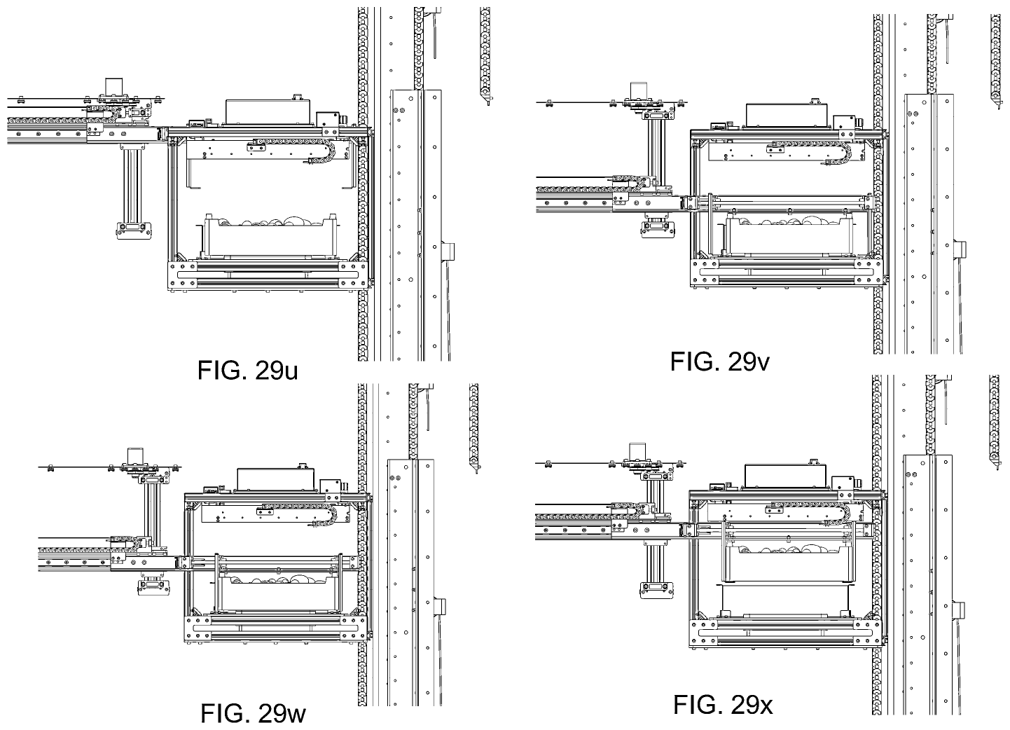

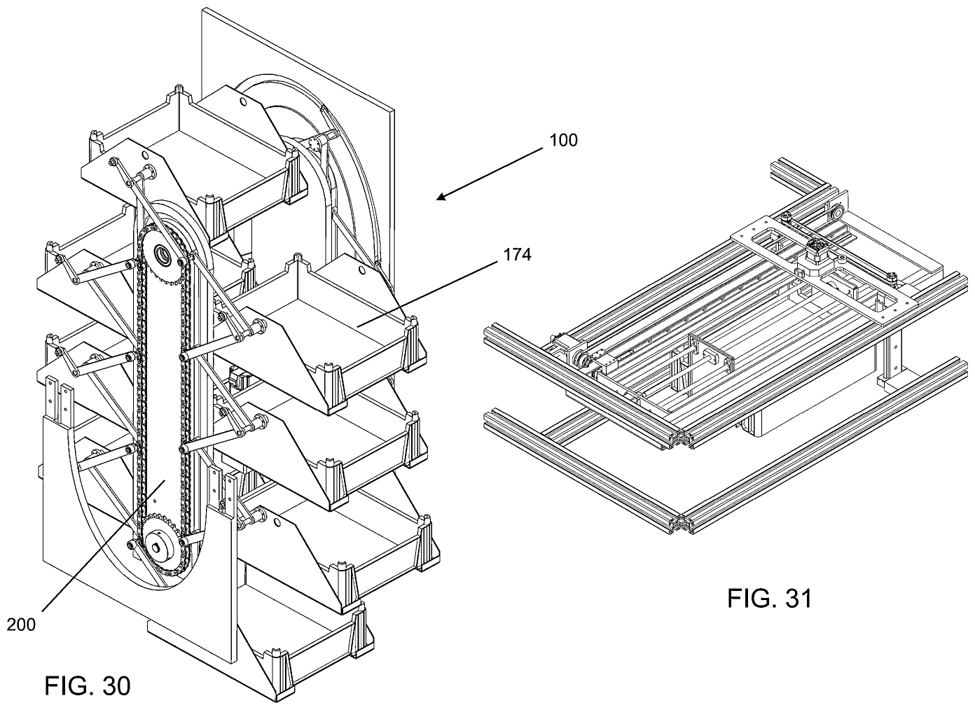

Referring now to FIGS. 29a-34, the packer 24 and box management system 100 are illustrated in the process of automatically exchanging a full packing bin 174 with a new empty packing bin 174. Referring to FIGS. 29a-29x and 30, the box management system 100 includes a carousel 200 to move packing bins 174 up towards the transfer frame 26. The box management system 100 can be loaded with empty packing bins 174 manually by an operator. The empty packing bins 174 are then automatically transferred from the box management system 100 to the transfer frame 26 where they are filled using the stem cutter 150 as described above.

FIGS. 29b-29j show loading an empty bin 174 from the box management system 100 into the transfer frame 26, using the box transfer mechanism. FIGS. 29k-29t show unloading a full bin 174 from the transfer frame 26 to the box management system 100, using the box transfer mechanism.

FIGS. 29u-29x show picking up a full bin 174 using the box transfer mechanism from a side view.

It may be noted that the bin transfer mechanisms are driven by a combination of motors, lead screws, and linear guides. The carousel is driven around by a combination of motors, sprocket chains, and guided channels. The scale of such mechanisms is clearly visible in FIGS. 29b-29x. This sequence of figures illustrates how the packing bin 174 can be transferred from the box management system 100 to/from the transfer frame 26 to automatically load and unload packing bins 174 as they are needed.

For evenly filling the packing bins 174 with fresh mushrooms 25, the transfer frame 26 is equipped with a vision system in the transfer system 120 to detect the packing bins 174, their position, and their fill level to be able to determine the optimal mushroom drop location in the packing bin 174. The vision system that detects the boxes and the position to put the mushroom 25 into the boxes can be located on the transfer frame 26 itself, such as on the top of the transfer frame 26 looking downwards towards the boxes and stem cutter 150. The vision system can also monitor mushroom transfers for detecting failed transfers as well as diseased/deformed/damaged mushrooms 25. The packer 24 uses a single scale to weight the individual mushrooms 25 and all individual packing bins 174 on the scale which is shown in, for example FIGS. 29o and 29p beneath the bin 174 that is being picked up.

Once the packing bins 174 on the transfer frame 26 are full, the packer 24 executes an automatic box transfer process which unloads the full packing bin 174 into the box management system 100 and reloads the transfer frame 26 with an empty packing bin 174 ready to be filled. Once there are no more empty packing bins 174 on the packer 24, an operator can unload the full packing bins 174 and insert a stack of fresh packing bins 174. The packing process can then be resumed.

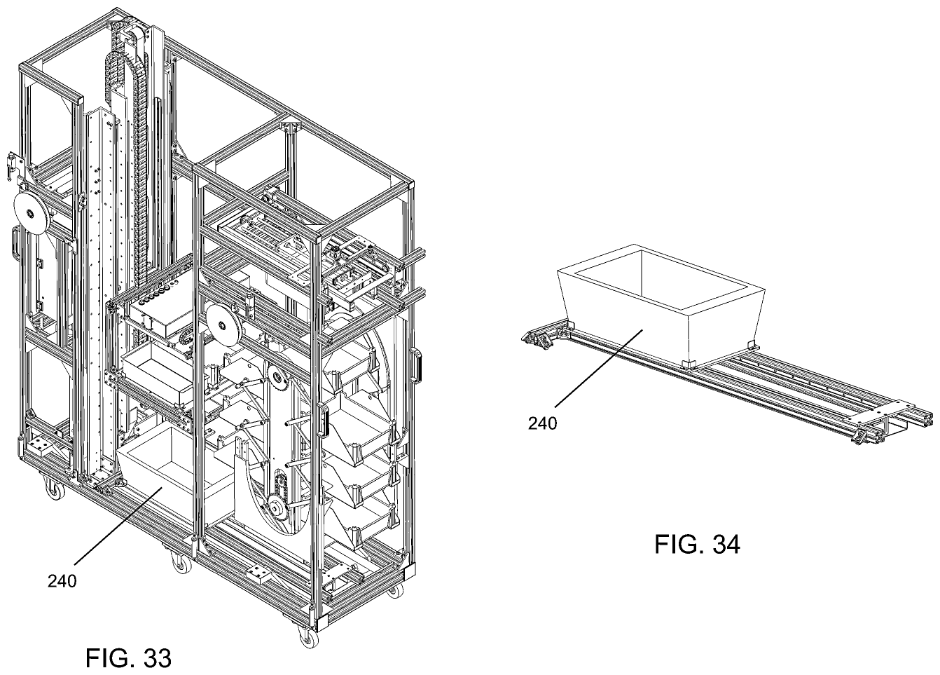

The packer 24 also has the ability to collect discarded stems from the cutting process in a smaller discard bin 172 in the transfer frame 26 as noted above. When the smaller discard bin 172 is full, the packer 24 can unload the contents of the small discard bin 172 into a bigger discard bin 240 located on the packer frame 104 (see also FIGS. 33 and 34).

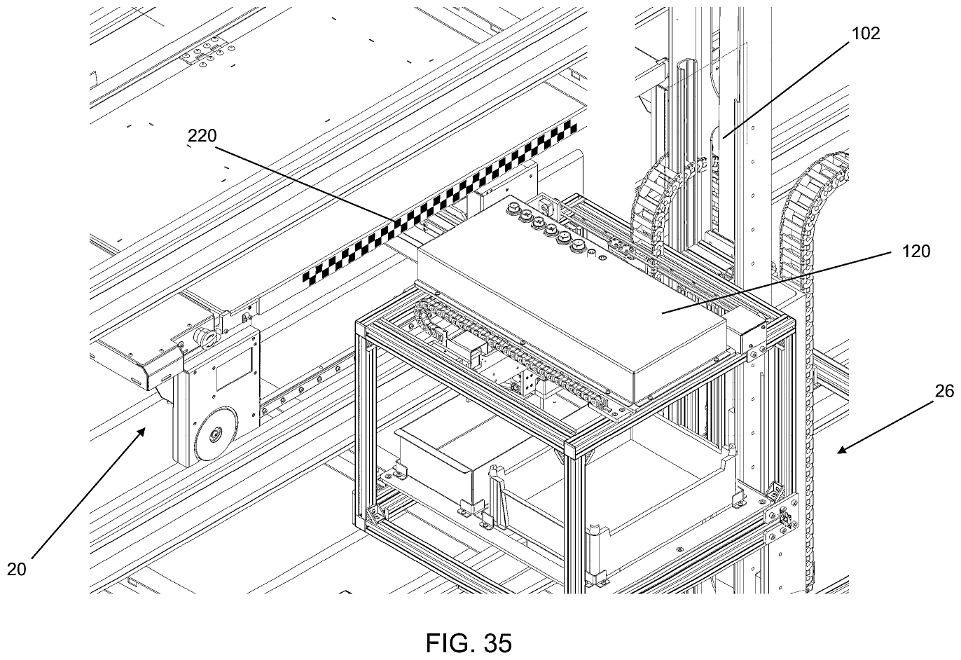

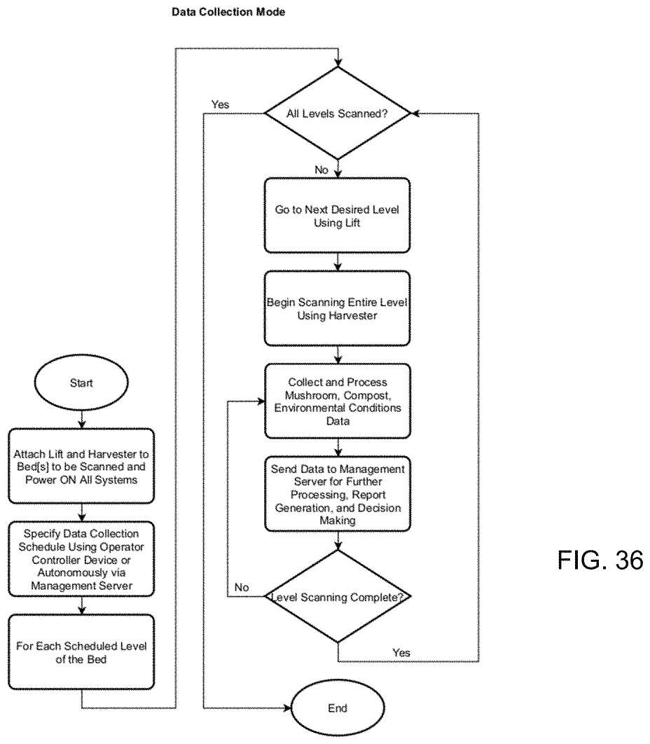

Referring now to FIG. 35, the packer 24 can interface and coordinate with the harvester 20 by detecting the harvester 20 via a fiducial marker 220 on the harvester 20. This allows for coordinate system synchronization between the harvester 20 and the packer 24.

As described above, the automated harvester 20 can operate the vision system rail 60 and picker 70 to scan and pick any and all mushrooms 25 grown using an existing multi-layer assembly 10. The process of harvesting in a growing room typically begins with the early forming of mushrooms 25 on the growing bed, i.e. on the growing medium or substrate. Specific mushrooms 25 are known to grow quicker than other mushrooms 25 and, as such, the apparatus needs to travel the beds at the different levels 12 to harvest the isolated early mushrooms 25. From this point on, the plan can be formed to operate a continuous travel path over the beds, monitoring the growth of the mushrooms 25 and harvest off mushrooms 25 once they reach optimal size. A single automated harvester 20 can be deployed at one level 12 after another, or multiple harvesters 20 can be deployed on multiple levels 12 at the same time and used individually to scan and target mushrooms 25 for picking.

The automated harvester 20 can be brought into a mushroom 24 growing room using the lift 22. The lift 22 can be attached to the bed frames by the rack and pinion mechanism described above. A drive motor on the lift can be used to index up and down the rack to raise and lower to the different levels 12. The controller on the lift 22 can position the lift 22 to be parallel with a specified level 12 of the mushroom bed so that the harvester 20 can drive off the lift and onto the side rails 16 of the mushroom bed as discussed and illustrated above. It may be noted that lift 22 has a special position when transferring a harvester 20 from the lift 22 to the bed 10, versus loading a harvester 20 onto the lift 22 from the bed 10. This is to address the case when the harvester rails on the bed 10 are not aligned vertically thus the lift rails do not perfectly align with the rails on the bed 10. To address this problem, the lift 22 detects the height of the bed rails on the left and right side separately, so when the harvester 20 needs to transfer on the bed 10, one can align the lift rails with the highest of the two bed rails (so the harvester 20 steps down onto the bed rails). When the harvester 20 is boarding the lift 22 from the bed 10, the lift 22 is aligned with the lowest of the two bed rails for that level, so that the harvester 20 steps down onto the lift 22. This way, the harvester 20 is not fighting gravity when transferring between lift/bed.

As the harvester 20 drives from the lift 22 onto the mushroom bed side rails 16, the vision system rail 60 moves along the bed to scan the mushrooms 25 growing on the substrate 22 and generates a 3D point cloud of the mushroom bed section that was scanned. The data acquired from the scanners can be sent to a local processor unit and/or can also be sent to a centralized server or host computer (not shown). The data collected by the centralized server may be used for optimization of the harvesting process. The local processor applies filters and user parameters to determine the optimal picking strategy. Once a section is finished being scanned the local processor unit determines if there are any candidates to harvest in the section based on the scanned data it received. If there are no candidate mushrooms 25 to harvest the harvester continues scanning the next target section and repeats the process until it reaches the physical end of the bed level 12. Once the end of the bed level 12 has been reached the harvester 20 reverses back to the lift without scanning. The lift 22 then raises or lowers the harvester 20 to a new bed level and the process repeats.

When the local processor unit determines that there was at least one candidate mushroom 25 within in the scanned section, the local processor unit instructs the harvester 20 to harvest the mushroom(s) 25. The strategy to detach the mushroom from the soil (substrate) incorporate several factors including, but not limited to, finger placement, angle of approach, mushroom shape, mushroom diameter, mushroom height, mushroom pivot point, and action(s) to perform (e.g., twist, pull, tilt, push). To harvest a mushroom the fingers 130 are positioned within the work area above the mushrooms 25 and the gantry 72 lowers them to grab mushroom with the fingers 130 and execute the appropriate strategy. After the mushroom 25 has been detached from the soil (substrate) it is raised back into the work area (mushroom is still held by the fingers 130 so it can freely travel to the side of the harvester 20 and into the transfer frame 26. It should be noted that only candidate mushrooms are harvested not all the mushrooms. Using the detected natural growth rate of the mushroom, when the harvester 20 returns to a specific section mushroom which were not candidates to harvest originally will become candidates in future passes.

FIG. 36 illustrates computer executable instructions that may be executed to implement a data collection mode by the system described herein. For the data collection mode, the lift 22 and harvester 20 are attached to the bed 10 to be scanned and all systems are powered on. A data collection schedule is specified using an operator controller device or autonomously via a management server. With this schedule, for each scheduled level 12 of the bed 10, the operator or server determines if all levels 12 have been scanned. If not, the harvester 20 is sent to the next desired level 12 and begins scanning the entire level 12. This allows the harvester 20 to collect and process mushroom, compost, and environmental condition data. The data is sent to the management server for further processing, report generation, and decision making. The harvester 20 determines if the level scanning is complete. If not, the harvester 20 continues to collect and process data until the level scanning is complete at which point it determines if all levels 12 have been scanned.

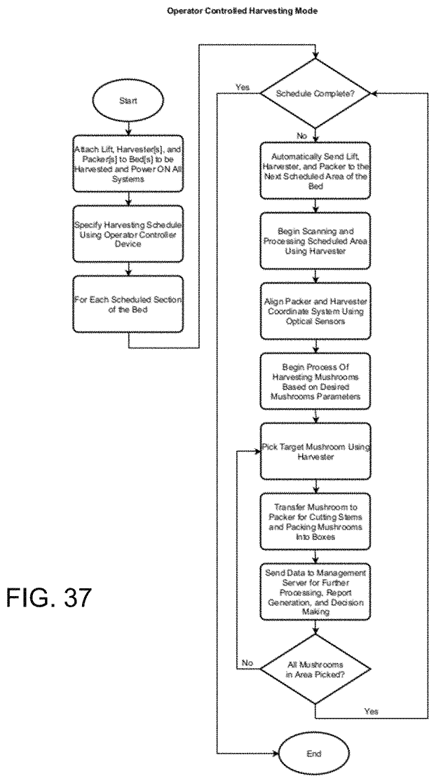

FIG. 37 illustrates computer executable instructions that may be executed to implement an operator controlled harvesting mode using the system described herein. In this example, the lift 22, harvester 20 and packer 24 are attached to the bed 10 and the systems are powered on. The harvesting schedule in this example is set using the operator controller device. For each scheduled section of the bed 10, the controller determined if the schedule is complete. If not, the lift 22, harvester 20 and packer 24 are sent to the next scheduled area of the bed 10 to begin scanning and processing the scheduled area using the harvester 20. The packer and harvester coordinate system are then aligned using optical sensors and the harvester 20 begins the process of harvesting mushrooms 25 based on desired mushrooms parameters as discussed above. A target mushroom 25 is picked using the picker 70 of the harvester 20 and the mushroom is transferred to the packer 24 for cutting stems 29 and packing the mushrooms 25 into the packing bins 174. Data is sent to the management server for further processing, report generation, and decision making. The system then determines if all mushrooms 25 in the area have been picked. If not, the next target mushroom 25 is picked before determining if the schedule is complete once that area is completed.

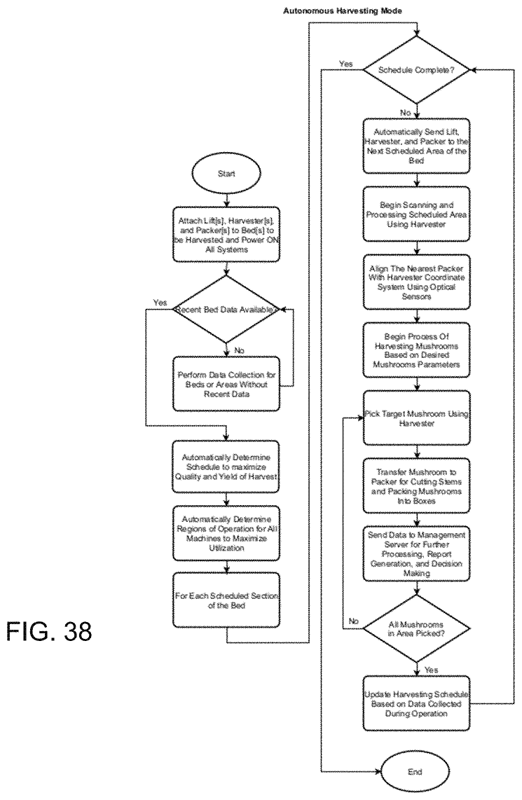

FIG. 38 illustrates computer executable instructions that may be executed to implement an autonomous harvesting mode using the system described herein. In this example, the lift(s) 22, harvester(s) 20 and packer(s) 24 are attached to the bed(s) 10 and the systems are powered on. The autonomous system determines if any recent bed data is available. If not, the system can perform data collection for beds 10 or areas in the beds 10 without recent data. The system then automatically determines a schedule to maximize quality and yield of the harvest and automatically determines regions of operation for all machines to maximize their utilization. Then, for each scheduled section of the bed(s) 10, the system determines that the schedule is not yet complete. Then, the lift 22, harvester 20 and packer 24 are sent to the next scheduled area of the bed 10. The harvester 20 begins scanning and processing the scheduled area and aligns with the nearest packer 24 with the harvester coordinate system using optical sensors. The process of harvesting mushrooms then begins based on the desired mushroom parameters and a target mushroom 25 is picked using the harvester 20. The picked mushroom is then transferred to the packer 24 for cutting stems and packing the mushroom 25 into the packing bin 174. Data is then sent to the management server for further processing, reporting generation, and decision making. The system then determined if all mushrooms in that area have been packed. If not, the next target mushroom in that area is picked until the area is completed. The harvesting schedule is then updated based on the data collected during operation before determining whether the schedule is complete.

In the autonomous mode shown in FIG. 38 it can be appreciated that the system automatically determines the best course of action based on the data collected using the data collection mode in FIG. 36. Each section and mushroom 25 can be scored and ranked using the data collected by the system, to then decide the number of machines required and what their schedule should be. That is, the system can automatically determine what sections of the bed 10 to pick, when to pick them and what to pick in each section.

Using the point cloud data, mushroom candidates and their features such as position, size, shape, orientation, volume, mass, and surrounding empty or occupied space is extractable with high precision and repeatability. By combining the mushroom bed ground information with the mushroom cap features both extracted from the point cloud, mushroom stem height, orientation, and pivot point are also available. With the mushroom parameters extracted for all mushrooms within a section, the process can be repeated for the remainder of section on the bed, from which mushroom statistics can be calculated. The data can be used to predict growth rates and locations of mushrooms allowing for the optimization of the harvest yield, speed, and quality. For the mushroom harvesting operation, the same procedure is repeated as described above for data collection but with the addition of calculating global and local strategies for picking. Upon the extraction of the mushroom features, a filtering stage can be performed to extract the mushrooms 24 that satisfy the requirements set by predetermined or predictive parameters.

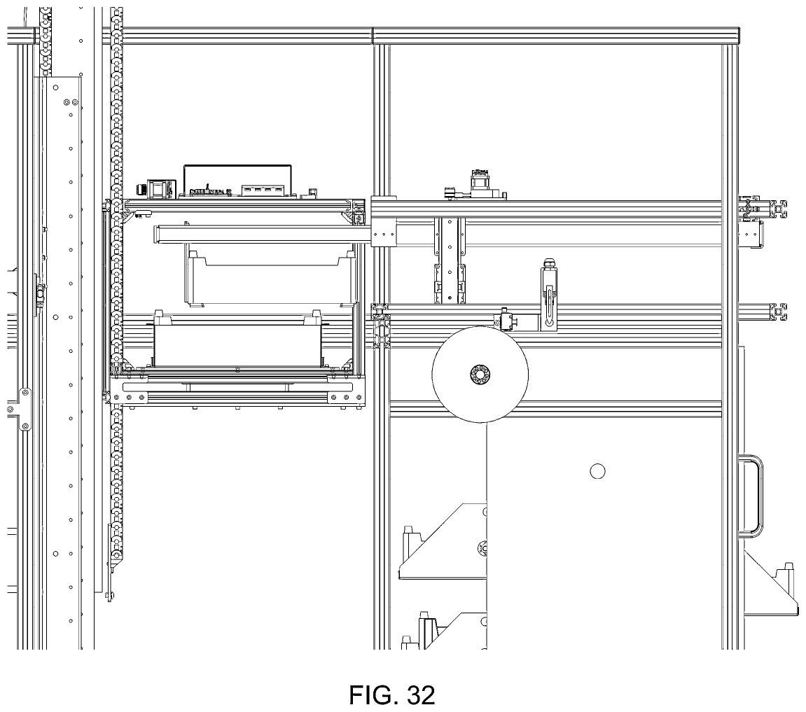

With a list of target mushrooms 24 per section of the growing bed, the local processing unit can calculate a global strategy that specifies the order of picking which is to be performed by the harvesting unit, taking mushroom cluster density, surrounding space, and timing into consideration as discussed above and shown in FIG. 32. For each mushroom 24 in that global picking order, the local processing unit calculates local strategies that determine the precise picking strategy required to pick the mushroom in the most optimal way while minimizing external contact and damage that may appear of the mushroom upon contact. The local strategy for each mushroom 24 can include calculating the optimal picking approach, points of contact with the harvesters grasping technology, picking motion, and picking direction. The local strategy is transferred over to the harvesting unit along with the mushroom features, where the harvesting unit performs the instructed task and provides the picking outcome feedback to the local processing unit. The local processing unit has the ability to control to harvesting unit drop off location and procedure for the mushrooms 24 that have been picked. The process is repeated for the remainder of the mushrooms selected by the global strategy, and then repeated for the remainder of the sections that have been selected.

It can be appreciated that the automated harvester 20 can also include a human machine interface (not shown), which can be configured as a control panel that is mounted on the harvester 20. The interface can also have a portable wireless equivalent called a control client. The interface displays current information about the harvester 20 such as current status, power levels, warnings or errors, etc., while providing the ability to control most actions of the harvester 20. Both local and portable versions of the interface can include emergency stop buttons for safety precautions which halt all physical motion on the device when pressed. The portable control client can be useful when the harvester 20 is out of reach and an unexpected situation occurs. The local control panel can interact with the user for modes such as pick assist where the machine can pause or request user interaction such as changing fingers or battery.

It can also be appreciated that the automated harvester 20 described herein differentiates itself from prior attempts at automated mushroom harvesting by arranging one or more scanners 100 as shown in FIG. 15 to cover the width of the mushroom growing bed, instead of the use of single, movable, or multiple 2D cameras as used in prior attempts. In addition, the present method processes 3D point data to extract mushroom information and their precise properties instead of using image processing techniques to process optical information extracted from 2D images. The presented apparatus does no rely on the optical properties of mushrooms captured by cameras, i.e. the color, intensity, and optical features but rather the pure geometrical data of the mushroom growing bed including the ground, immature mycelium formations, mushrooms, and any other formation or object that may appear.

The automated harvester 20 described herein also does not need to rely on environmental conditions such as ambient light variations, i.e. can work with artificial or natural light and without the presence of environmental light. The present apparatus and its arrangement of 3D scanners provides several areas of scanner overlap therefore overcoming issues of mushroom self-occlusion. By processing 3D data instead of 2D data, the apparatus described herein can consistently extract precise geometric information for the whole mushroom cap surface, partial stem surface, the empty or occupied space surrounding the mushroom, and the ground on which it grows on instead of simply the 2D/3D mushroom centroid and their diameter as per prior attempts. The present solution can also calculate the approach, gripper-to-mushroom contact points, and global and local mushroom pick strategies with the highest precision without the need for any additional measuring devices to assist the grasping and picking of the mushrooms. The present system reduces grasping contact forces and the chance of collision with neighboring mushrooms or obstacles to a minimum during the grasping approach, contact, and picking motion.

The present solution can also use mathematical models on the captured 3D data to extract or predict the properties of mushrooms 25 such as their position, size, shapes, orientations, growth rates, volumes, mass, stem size, pivot point, and maturity. The present system can also predict the time at which the mushroom 24 will reach pre-defined maturity and optimize its picking strategy to maximize yield of said pre-define target or goal. The present system can detect the presence, position, and communicate with external devices which are used to aid the process of harvesting, e.g., control devices, packaging devices, product conveying, and product or robot transportation devices.

Unless defined otherwise, all technical and scientific terms used herein have the same meaning as commonly understood by one of ordinary skill in the art to which this technology belongs. Also, unless indicated otherwise, except within the claims, the use of “or” includes “and” and vice versa. Singular forms included in the claims such as “a”, “an” and “the” include the plural reference unless expressly stated otherwise. All relevant references, including patents, patent applications, government publications, government regulations, and academic literature are hereinafter detailed and incorporated by reference in their entireties. In order to aid in the understanding and preparation of the system, method and apparatus described herein, the above illustrative, non-limiting, examples are provided.

The term “comprising” means any recited elements are necessarily included and other elements may optionally be included. “Consisting essentially of” means any recited elements are necessarily included, elements that would materially affect the basic and novel characteristics of the listed elements are excluded, and other elements may optionally be included. “Consisting of” means that all elements other than those listed are excluded. Embodiments defined by each of these terms are within the scope of the claimed appended hereto.

The term “about” modifying any amount refers to the variation in that amount encountered in real world conditions of producing materials such as polymers or composite materials, e.g., in the lab, pilot plant, or production facility. For example, an amount of an ingredient employed in a mixture when modified by about includes the variation and degree of care typically employed in measuring in a plant or lab producing a material or polymer. For example, the amount of a component of a product when modified by about includes the variation between batches in a plant or lab and the variation inherent in the analytical method. Whether or not modified by about, the amounts include equivalents to those amounts. Any quantity stated herein and modified by “about” can also be employed in the present system, method and apparatus, as the amount not modified by about.

In this specification and in the claims that follow, reference will be made to a number of terms that shall be defined to have the meanings below. All numerical designations, e.g., dimensions and weight, including ranges, are approximations that typically may be varied (+) or (−) by increments of 0.1, 1.0, or 10.0, as appropriate. All numerical designations may be understood as preceded by the term “about”.

Terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

The properties of mushrooms include their position within the mushroom growing bed (i.e. their coordinates), size of the mushroom cap, shapes of the mushroom caps, orientations of the mushrooms (tilted, straight and so forth), growth rates, volumes, mass, stem size, pivot point, maturity, and surrounding space (distance between mushrooms).

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the automated harvester 10, any component of or related thereto, etc., or accessible or connectable thereto. Any application or module herein described may be implemented using computer readable/executable instructions that may be stored or otherwise held by such computer readable media.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A method of harvesting items grown in growing beds, the method comprising:
i) loading a harvester onto a lift, the harvester comprising a vision system to scan and detect items in growing beds and a picker for picking items growing in the growing bed;
ii) operating the lift to attach to and climb the growing bed to a specific one of a plurality of levels of the growing bed;
iii) enabling the harvester to be deployed onto the specific level of the growing bed;
iv) moving a packer to be aligned with the specific level and an area of the specific level and be configured to receive items picked by the picker; and
v) repeating steps i), ii), iii), and iv) for a next area to be picked, wherein the next area is part of the same specific level of the growing bed, a next specific level of the growing bed, or a next growing bed.

2. The method of claim 1, further comprising processing the received items to pack and measure the received items on the packer.

3. The method of claim 2, wherein the items comprise mushrooms and/or other growing material, and the mushrooms and/or other growing material are processed by trimming a stem and packing the trimmed items in boxes positioned at the area by the packer.

4. The method of claim 1, further comprising obtaining a picking schedule, the specific level being determined based on the picking schedule.

5. The method of claim 4, further comprising using the lift and harvester to perform a scan of at least one of the levels of the growing bed to obtain data to determine the schedule.

6. The method of claim 5, further comprising automatically determining the schedule to maximize quality and yield of a harvest.

7. The method of claim 1, further comprising deploying a plurality of harvesters on the same growing bed at different levels.

8. The method of claim 1, further comprising sending data to a management server for further processing.

9. The method of claim 1, further comprising repeating step v) until a picking schedule has been completed.

10. The method of claim 5, wherein the items comprise mushrooms and the scan is executed autonomously to collect and process mushroom, compost and environmental conditions data.

11. The method of claim 1, wherein the packer comprises a transfer frame on a telescopic arm to move between the levels of the growing bed.

12. The method of claim 11, wherein the packer comprises a box management system to automatically remove full packing bins from the transfer frame and to insert empty packing bins into the transfer frame.

13. The method of claim 1, further comprising loading the lift on a cart and moving the lift towards and engagement with the growing bed.

14. The method of claim 1, wherein the lift engages a track system on the growing bed to climb between the plurality of levels.

15. The method of claim 1, wherein the lift comprises a sensor to identify the specific level of the growing bed automatically.

16. The method of claim 1, wherein the lift comprising a pair of tracks configured to align with similar tracks on the growing bed levels to permit the harvester to drive off the lift and onto the growing bed level.

17. A harvesting system, comprising:
a lift attachable to a growing bed and configured to climb between a plurality of levels of the growing bed;
a harvester comprising a vision system to scan growing beds and a picker for picking items growing in the growing bed;
a packer attachable to the growing bed and moveable along the length of the bed and between a plurality of levels of the growing bed to align with the harvester to transfer picked items from the harvester to the packer; and
a control system to automate at least one of the harvester, lift and packer.

18. The system of claim 17, wherein the packer comprises a transfer frame on a telescopic arm to move between the levels of the growing bed.

19. The system of claim 18, wherein the packer comprises a box management system to automatically remove full packing bins from the transfer frame and to insert empty packing bins into the transfer frame.

20. The system of claim 17, further configured to load the lift on a cart and move the lift towards and engagement with the growing bed.

21. The system of claim 17, wherein the lift engages a track system on the growing bed to climb between the plurality of levels.

22. The system of claim 17, wherein the lift comprises a sensor to identify the specific level of the growing bed automatically.

23. The system of claim 17, wherein the lift comprising a pair of tracks configured to align with similar tracks on the growing bed levels to permit the harvester to drive off the lift and onto the growing bed level.
